(19) United States
(12) Patent Application Publication
(10) Pub. No.: US 2003/0095158 A1
(43) Pub. Date: May 22, 2003

(54) Printer

(76) Inventors: Masato Akitaya, Kanagawa (JP); Yumiko Yamaguchi, Kanagawa (JP)

Correspondence Address: PATENTS+TMS, A Professional Corporation, 1914 North Milwaukee Avenue, Chicago, IL, 60647, US

(21) Appl. No.: 10/301,269

(22) Filed: Nov. 21, 2002

(30) Foreign Application Priority Data
Nov. 22, 2001 (JP) 2001-357503

(51) Int. Cl. B41J 29/38

(52) U.S. Cl. 347/14

(57) ABSTRACT

Disclosed is a printer. A printer of the present invention has: a printer body; a printer head movably mounted on said printer body for reciprocating with respect to said printer body; a sensor for detecting a movement of said printer head; head turnback position detecting means for detecting a turnback position of said printer head based on pulse signals output from said sensor; pulse resolution changing means for changing a resolution of the pulse signals from said sensor based on a detected result obtained by said head turnback position detecting means and generating a reference pulse signal for a printing position. The printer carries out a printing operation via said printer head as the printer determines the position of said printer head based on the reference pulse signal for the printing position.

### FIELD OF THE INVENTION

The present invention relates to a printer.

### DESCRIPTION OF THE PRIOR ART

Cycolor® type printers are well known as one of printers using photosensitive printing papers. The Cycolor type printers reproduce (print out) an image by printing it out on a photosensitive printing paper (Cycolor type printing paper). This type of paper is coated with a large number of photosensitive microcapsules called cyliths (Cycolor medium).

These cyliths contain cyanic, magenta, or yellow ink, and are provided on the paper at random. Cyliths containing cyanic ink, magenta ink, or yellow ink harden when exposed to emitted R (red) light, G (green) light, or B (blue) light, respectively. These colors have a relation of the complementary colors. Namely, when red light is emitted, cyanic capsules containing cyanic ink harden. Similarly, magenta capsules containing magenta ink harden when green light is emitted, and yellow capsules containing yellow ink harden when the blue light is emitted.

In a Cycolor type printer, image reproduction (development) is effected by emitting, in an exposure step, light of colors corresponding to image data, via a head for exposure to the printing paper, thereby exposing the printing paper. The exposed printing paper is then subject, in a development step, to mechanical pressure, and capsules that have not been caused to harden are crushed and their ink released to mix with that of other crushed capsules. In this way, color is imparted to the printing paper to correspond to the image data, and the desired image is reproduced.

To exemplify, if only red light is emitted on the printing paper, only cyanic capsules harden, and when the paper is subject to mechanical pressure in the development step, unhardened magenta and yellow capsules are crushed, and their ink released to mix and produce a color red on the paper; similarly, emission of green light causes only magenta capsules to harden, and unhardened cyanic and yellow capsules are crushed, and their ink released to mix and produce a color green on the paper; and similarly, emission of only blue light causes only yellow capsules to harden, and unhardened cyanic and magenta capsules are crushed, and their ink released to mix and produce a color blue on the printing paper.

By varying an irradiation time and/or intensity of each of a red, green and blue light exposure, an amount of hardened microcapsules on the paper can be varied and mixing of each of the three colored ink, thereby also carried to produce a range of neutral colors.

By the way, in conventional printers of this type, a light emitting diode (LED) head is used to effect exposure. Such a head is provided with each of a red, green and blue LED, and these LEDs are mounted in alignment on a substrate of the head.

In the exposure step, a paper for printing is placed in proximate and opposing relation to the LED head, which scans the paper. While the LED head is moved back and forth along a main scanning direction, the photosensitive printing paper is moved in a sub scanning direction, which is substantially perpendicular to the main scanning direction. In this way, a latent image is recorded (formed) on the paper. This exposure is carried out not only when the LED head moves one direction of the main scanning direction but also when the LED head moves another direction of the main scanning direction.

Since RGB LEDs provided on the LED head are spaced apart from each other and therefore simultaneously face different dot positions on a printing paper to be exposed, data of an image to be printed must be set to registers simultaneously (must be set to coincide) with respective RGB LED positions in each exposure step (scan). Thus, it is necessary to calculate a position of the LED head (printing position), i.e., positions of the RGB LEDs to set the image data.

In the conventional art, to obtain positional information on the LED head a sensor is provided thereon, and a linear scale on which a plurality of white and black patterns are alternately arranged is provided on a printer body. Also, provided in the printer for obtaining positional information are a light emitting section and a light receiving section. From the emitting section, light is emitted toward the linear scale from which it is reflected to be received in the receiving section. The received light then undergoes photoelectric-transfer. An encoded pulse is output from the sensor while the LED head is moving, and the position of the LED head, i.e., the position of each LED with respect to the main scanning direction is obtained by counting these encoded pulses.

A drawback of the conventional art, however, is that since a printing resolution (image resolution) is determined by a linear encoder comprising the linear scale and the sensor, if a printing resolution is changed, the linear scale and the sensor in the linear encoder must also be changed to correspond to a required resolution. Thus, dedicated linear scales and sensors corresponding to a variety of printing resolutions must be prepared, thereby increasing the cost of the printer.

### SUMMARY OF THE INVENTION

It is therefore an object of the present invention to provide a printer that can carry out a printing operation with a predetermined printing resolution without changing a type of sensor and linear scale or adding another type of sensor and linear scale, and that is able to accurately print out (reproduce) an image corresponding to image data on a printing paper.

In order to achieve the above object, the present invention is directed to a printer. In an embodiment of the present invention, the printer comprising: a printer body; a printer head mounted on the printer body in a reciprocally movable manner with respect to the printer body; a sensor for detecting a movement of the printer head to generate pulse signals; head turnback position detecting means for detecting a turnback position of the printer head based on the pulse signals output from the sensor; and pulse resolution changing means for changing a resolution of the pulse signals from the sensor based on a detected result by the head turnback position detecting means and generating a reference pulse signal for a printing position. The printer is configured so as to carry out a printing operation via the printer head while determining the position of the printer head based on the reference pulse signal for the printing position.

In this invention, it is preferred that the pulse signals include a first pulse signal and a second pulse signal, the phases of the first and second pulse signals being shifted relative to each other by a predetermined value.

Here, the printer of the present invention may further comprise a scale provided on said printer body. In this case, the sensor is provided on the printer head, and has a light emitting section for emitting light toward the scale and a plurality of light receiving sections for receiving reflected light that is emitted from the light emitting section and reflected from the scale to output signals, and a first pulse signal and a second pulse signal are generated based on the signals from the light receiving sections.

Further, in this invention, it is preferred that, when the printer head moves in a predetermined direction, the phase of the first pulse signal leads to the phase of the second pulse signal by a predetermined value, and when the printer head moves in a reverse direction, the phase of the first pulse signal lags behind the phase of the second pulse signal by a predetermined value. In this case, the phase shift between the pulses of the first and second pulse signals may be 90 degrees, and duty ratios of the pulses of the first and second pulse signals may be 50%, respectively.

Moreover, in this invention, it is preferred that the head turnback position detecting means determines a turnback position of the printer head at a timing when a level of one of the first and second pulse signals changes twice with a level of the other pulse signal being unchanged.

Further, in this invention, it is preferred that the head turnback position detecting means compares a level of the pulse of the second pulse signal at a rising point of the pulse of the first pulse signal with a level of the pulse of the second pulse signal at a falling point of the pulse of the first pulse signal, and determines a later timing in the rising and falling points of the first pulse signal as a first timing in a case that both levels of the second pulse signal at the two points are either high or low. And it is preferred that the head turnback position detecting means also compares a level of the pulse of the first pulse signal at a rising point of the pulse of the second pulse signal with a level of the pulse of the first pulse signal at a falling point of the pulse of the second pulse signal, and determines a later timing in the rising and falling points of the second pulse signal as a second timing in a case that both levels of the first pulse signal at the two points are either high or low. In this case, the head turnback position detecting means finally determines the earlier timing in the first and second timings as the turnback position.

Moreover, the pulse resolution changing means comprises: an a-multiply pulse signal generating circuit for generating an a-multiply pulse signal having a times frequency of the frequency of the pulse signals from the sensor (here, “a” is any one of two or more integral numbers.); and a divider for dividing the a-multiply pulse signal so that the reference pulse signal for the printing position becomes substantially symmetrical at the center of an actual turnback point of the printer head on the basis of the detected result of the head turnback position detecting means. In this case, the a may be four.

In this case, the divider may have a counter, and it is preferred that, when the divider divides the a-multiply pulse signal so that a frequency of the divided pulse signal becomes n times that of the a-multiply pulse signal (here, “n” is any one of two or more integral numbers.), the divider carries out a dividing operation by counting up or down a number of pulses of the a-multiply pulse signal by means of the counter and generating pulses in synchronization with n^{th} count, and, when the head turnback position detecting means detects the turnback position of the printer head, the dividing operation is switched between a count-up operation and a countdown operation.

Further, it is preferred that the divider starts to count up the pulses from 1 after a counting value in the counter has been returned to 0 when the counter counts the n^{th} pulse in the count-up operation, and that the divider starts to count down the pulses from n−2 after a counting value in the counter has been returned to n−1 when the counter counts the n^{th} pulse in the countdown operation.

Moreover, the counter may be a b-bit up/down counter (here, “b” is any one of two or more integral numbers.), and the n may be 2^{b-}1.

In this invention, it is preferred that the divider generates the reference pulse signal for the printing position by dividing the a-multiply pulse signal so that a frequency of the divided pulse signal becomes n times that of the a-multiply pulse signal and further dividing the divided pulse signal.

Further, in this invention, it is preferred that a duty ratio of the pulse of the reference pulse signal for the printing position is 50%.

In this invention, a light source may be mounted on the printer head, and the printer may be configured so as to reproduce an image on a photosensitive printing paper by exposing the photosensitive printing paper by means of the printer head.

Further, in this invention, it is preferred that a light source for emitting red light, a light source for emitting green light and a light source for emitting blue light, are mounted on the printer head, and the printer is configured so as to reproduce an image on a photosensitive printing paper by exposing the photosensitive printing paper by means of the printer head.

In this case, the printer of the present invention may further comprise: a first group of registers for setting up image data corresponding to the light source for emitting red light, the image data corresponding to the light source for emitting green light, and the image data corresponding to the light source for emitting blue light; and a second group of registers for holding the image data, which is set up in the first group of registers. And it is preferred that the printer is constructed so as to set up next image data in the first group of registers and to drive each of the light sources mounted on the printer head by using the image data that is held in the second group of registers in parallel.

Moreover, it is preferred that a plurality of the light sources for emitting red light, a plurality of the light sources for emitting green light and a plurality of the light sources for emitting blue light are mounted on the printer head.

In this invention, the printer may be configured so as to reproduce an image on a printing paper that contains a plurality of photosensitive microcapsules. Also, the printer may be a Cycolor type printer.

### BRIEF DESCRIPTION OF THE DRAWINGS

FIG. 1 is a block diagram illustrating an embodiment of a printer according to the present invention.

FIG. 2 is a timing chart illustrating a timing-relation between two encoded pulses FG1 and FG2 and an LR signal in the printer shown in FIG. 1.

FIG. 3 is a bottom plan view illustrating an example of a structure of an LED head in the printer shown in FIG. 1.

FIG. 4 is a block diagram illustrating an example of a structure of one principal part of gate IC in the printer shown in FIG. 1.

FIG. 5 is a timing chart illustrating a timing-relation between image data and an LED control signal in the printer shown in FIG. 1.

FIG. 6 is a timing chart illustrating a timing-operation of setting image data to a first group of registers in the printer shown in FIG. 1.

FIG. 7 is a timing chart illustrating a timing-operation of holding image data in a second group of registers in the printer shown in FIG. 1.

FIG. 8 is a block diagram illustrating an example of a structure of a pulse resolution converting circuit (pulse resolution converting means), one principal part of gate IC in the printer shown in FIG. 1.

FIGS. 9 and 10 are block diagrams illustrating an example of a structure of a turnback detecting circuit of the pulse resolution converting circuit shown in FIG. 8.

FIG. 11 is a timing chart illustrating a relationship between pulses when generating a reference pulse signal α at a printing position in the printer shown in FIG. 1.

FIGS. 12 and 13 are timing charts illustrating a relationship between pulses when generating a signal LR_N in the printer shown in FIG. 1.

FIGS. 14 and 15 are timing charts illustrating a relationship between input pulses A and B, a signal LR_N, and a pulse A2R+B2R in the printer shown in FIG. 1.

FIG. 16 is a diagram illustrating an operation when an up/down counter of the printer shown in FIG. 1 counts up.

FIG. 17 is a diagram illustrating an operation when an up/down counter of the printer shown in FIG. 1 counts down.

FIGS. 18 and 19 are timing charts illustrating an operation of dividing when an LED head of the printer shown in FIG. 1 turns back.

FIGS. 20-27 are timing charts illustrating an operation of an up/down counter etc. when an LED head of the printer shown in FIG. 1 turns back.

### DETAILED DESCRIPTION OF THE PREFERRED EMBODIMENTS

With reference to the appended drawings, a detailed description of the preferred embodiment of a printer according to the present invention will be given below.

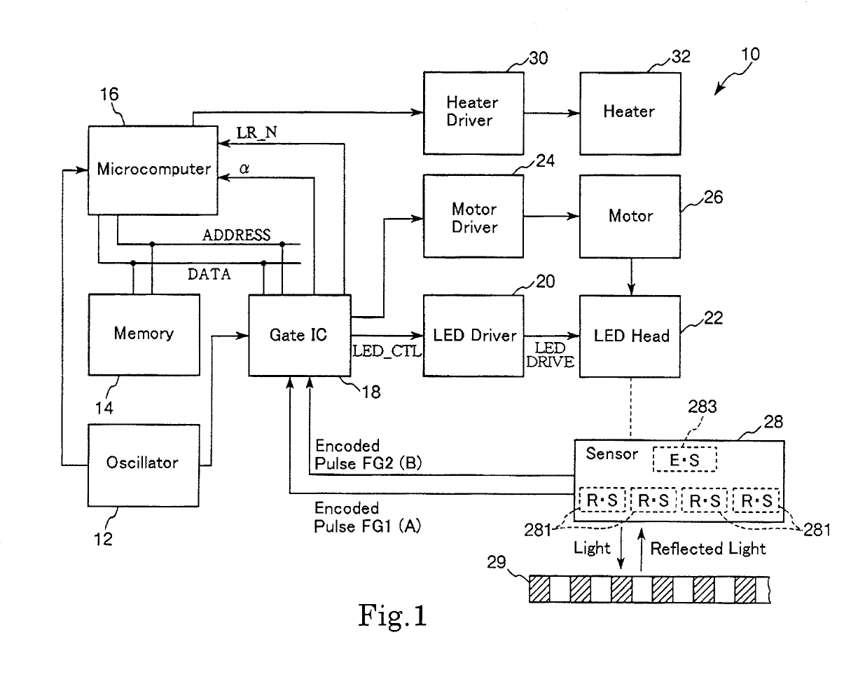

FIG. 1 is a block diagram illustrating an embodiment of a printer according to the present invention. The printer 10 shown in FIG. 1 reproduces (prints out) on a photosensitive printing paper an image corresponding to image data received from an image data source, which supplies the image data to the printer 10. As shown in FIG. 1, the printer 10 comprises a printer body and an LED head 22 (optical head for exposing) that is movably mounted on the printer body for reciprocating motion (i.e., that is mounted on the printer body in a reciprocally movable manner) as a head for the printer.

Further, as shown in FIG. 1, the printer 10 comprises: an oscillator 12; a memory 14; a microcomputer 16; a gate IC (digital IC) 18; an LED driver 20; a motor driver 24 and a motor 26; a linear encoder having a linear sensor 28 for detecting a movement of the LED head 22 and a linear scale 29; and a heater driver 30 and a heater 32.

Here, the image data is supplied by a digital device such as a personal computer (PC), or a digital camera, which can handle image data as digital data; or is supplied by an analog device such as a video player (VCR), or a television set (TV), which can handle image data as video signals, compatible with systems such as NTSC and PAL.

The printer 10 is connected to a digital device such as a PC via a parallel port. The digital data transmitted by the digital device via serial communication or the like is received by the printer 10 as image data. Also, the printer 10 is connected to an analog device such as a VCR via a video terminal. The video signals transmitted by the analog device are received by the printer 10 as image data.

As stated, the image data source may be either a digital or an analog device, and in practice, any device that can transmit image data to the printer 10 can be utilized as an image data source. Similarly, a system for connecting the printer 10 to the image data source is not limited to any one interface; and thus image data formats can be transmitted using any known communication protocol and interface standard.

Further, in the printer 10 various types of photosensitive printing papers can be used; such as a printing paper coated with photosensitive microcapsules (cyliths) (Cycolor® medium, Cycolor type printing paper), or a Polaroid® film, both of which are known.

Still further, (not shown in FIG. 1) the printer 10 is provided with power supply circuits for supplying power at a given voltage to various sections mentioned above; an interface circuit for interfacing between the printer 10 and the image data source; a video decoder for decoding video signals and converting image data to digital data; a pick-up mechanism (initial feed mechanism); and a mechanism for feeding a printing paper.

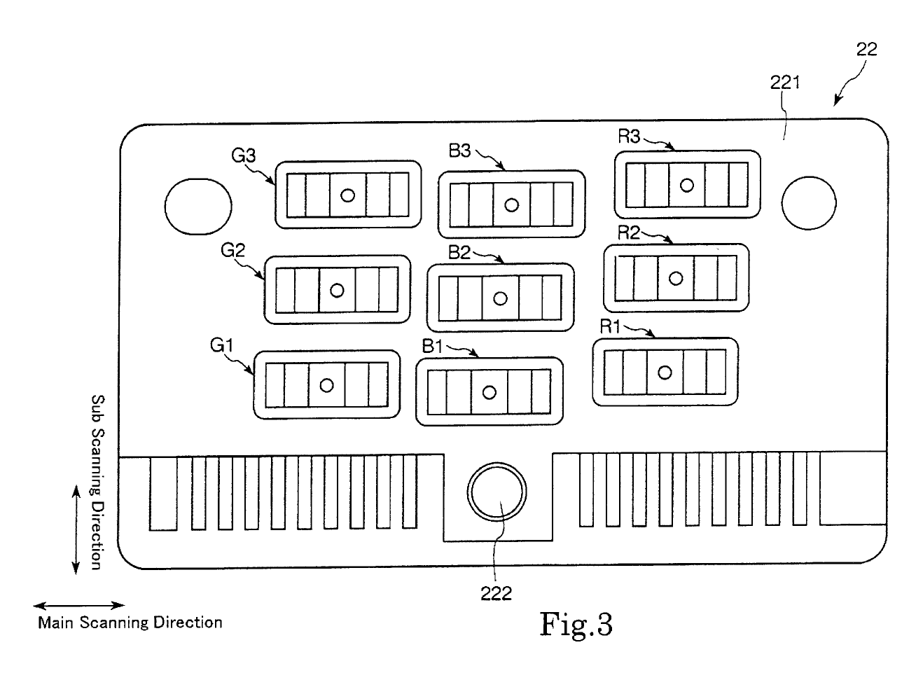

In the present embodiment, the printer 10 is a Cycolor type printer that reproduces an image on a printing paper coated with photosensitive microcapsules (Cycolor mediums). In the printer 10 a pressure mechanism 222 is provided for mechanically pressurizing an exposed printing paper to develop an image (developing process) (see FIG. 3). The pressure mechanism 222 may be either spherical or cylindrical in form.

Hereinafter, each of the elements of the printer 10 will be described in turn.

In the printer 10 shown in FIG. 1 the oscillator 12 generates clock signals having a predetermined frequency. These clock signals are supplied to elements of the printer 10 via the microcomputer 16 and the gate IC 18, whereby such elements are caused to operate synchronously.

The memory 14 is a buffer for storing the image data transmitted from the image data source. The memory 14 may comprise any known semiconductor memory. Examples include various types of RAM (Random Access Memory) such as SRAM (Static RAM), and DRAM (Dynamic RAM); and nonvolatile memories such as EPROM (Erasable Programmable Read-Only Memory), EEPROM (Electrically Erasable Programmable Read-Only Memory); and also flash memory.

The microcomputer 16 detects coordinate positions of a plurality of LEDs mounted on the LED head 22, and functions to control communication of image data from the image data source; the heater driver 30; LED current (light intensity of an LED); and the mechanical elements, such as the pick-up mechanism of a printing paper and the mechanism for feeding a printing paper. Further, the microcomputer 16 is able to detect operation errors that may occur in the printer 10.

The gate IC 18 functions to control each of the LED driver 20, the motor 26 via the motor driver 24 (motor servo), and the memory 14.

The microcomputer 16, the memory 14, and the gate IC 18 are connected to each other via an address bus “ADDRESS” and a data bus “DATA”. The image data stored in the memory 14 can be accessed by both the microcomputer 16 and the gate IC 18 via the address bus “ADDRESS” and the data bus “DATA.”

The image data supplied from the image data source is transmitted from microcomputer 16 to the memory 14 via the data bus “DATA,” and is written (stored) in a given address specified in the memory 14.

During printing of an image onto a printing paper, the microcomputer 16 reads out image data stored in the memory 14, and the read-out image data is then transmitted, along with its corresponding address data, to the gate IC 18.

A control means for controlling the driving of the printer 10 includes the microcomputer 16 and the gate IC 18.

In the preceding description of the present embodiment, a variety of functions are shared by the microcomputer 16 and the gate IC 18, but as will be apparent to one skilled in the art sharing of such functions is susceptible to a variety of modifications, as required.

The LED head 22 is able to expose a printing paper, and is provided with one or more LED(s) (R-LED) emitting red light; one or more LED(s) (G-LED) emitting green light; and one or more LED(s) (B-LED) emitting blue light. The gate IC 18 controls the driving (for example, the emission timing) of these LEDs at the LED head 22 via the LED driver 20.

In the present invention, the LED head 22 may be provided with only one LED corresponding to each color (red, green and blue), i.e., R-LED, G-LED and B-LED; or, alternatively, it may be provided with a plurality of LEDs, each corresponding to any one or two such colors; or may be provided with a plurality of LEDs, each of which may correspond to any one such color. By enabling a plurality of LEDs to correspond to any one color, it is possible to increase a printing speed, and thereby enable printing of a high-resolution image, even in a case that adequate light is lacking. It is also to be noted that in the present embodiment, the LED head 22 is provided with three LEDs, corresponding to any one color (see FIG. 3).

In the present embodiment, the head for a printer (printer head) is not limited to the LED head 22 (i.e., the light source is not limited to the LED), and any printer head known in the art (for exposure) may be used that is capable of utilizing a light source of a predetermined wavelength for exposure of a photosensitive printing paper.

It should also be noted here that a printer head for use in the present embodiment is not limited to that described above for exposure.

The motor 26 is driven by the motor driver 24 under control of the gate IC 18. During a printing operation, the motor 26 is driven to pick up individual sheets of printing paper from a storage section by means of the pick-up mechanism (not shown), which mechanism has an initial predetermined setting. The LED head 22 is caused to reciprocate (move back and forth) at a given constant speed in a main scanning direction by means of a head moving mechanism, for example, a gear mechanism (not shown). During this operation, the printing paper is fed by a printing paper feeding mechanism (not shown) in a sub scanning direction that is substantially perpendicular to the main scanning direction. At this stage, the printing paper is exposed by the LED head 22, and a latent image corresponding to the image data is recorded (formed) on the printing paper.

The linear scale 29 and the sensor 28 are utilized to detect a position (coordinate position) of the LED head 22 in the main and sub scanning directions with respect to a printing paper, i.e., to detect each dot (pixel) during a reciprocating motion of the LED head 22, and to detect a direction of movement of the LED head 22 with respect to the printing paper.

The linear scale 29 is utilized in an encoder provided with a plurality of monochrome patterns in bar form. The linear scale is placed at a predetermined position spaced apart from the LED head 22, in such a way that the LED head 22 can be moved in the main scanning direction relative to the linear scale. The patterns of the linear scale 29 maintain a predetermined constant interval (a predetermined pitch) along the direction of movement of the LED head 22 (i.e., along the main scanning direction). In the present embodiment, the pitch of the patterns corresponds to the pitch of the pixel of an image.

On the other hand, the sensor 28 has an emitting section 283 for emitting light toward the linear scale 29 and four receiving sections 281 for receiving reflected light that is emitted from the emitting section 283 and reflected from the encoder. The received light then undergoes photoelectric-transfer. The emitting section 283 and the receiving sections 281 are provided at an LED head 22 side. Further, as shown in FIG. 1, the receiving sections 281 are arranged at four positions spaced apart from each other in the main scanning direction.

Here, an LED (light emitting diode) can be used as the emitting section 283, and a photodiode or a phototransistor can be used as the receiving section 281.

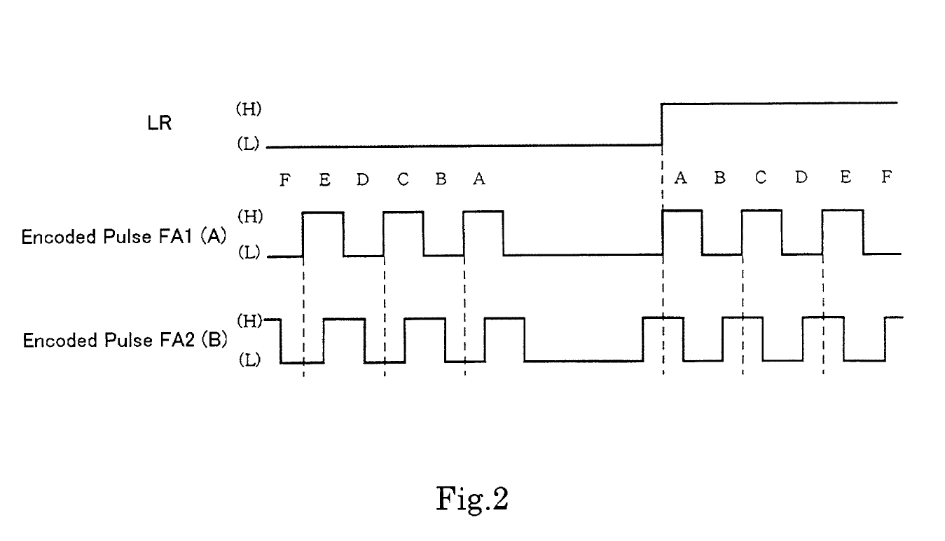

In the present embodiment, the LED head 22 and the sensor 28 are integrated in a carriage (not shown). As the carriage (i.e., the LED head 22) is moved, the sensor 28 outputs two encoded pulses FG1 (first encoded pulse) and FG2 (second encoded pulse), which have a 50% duty ratio (i.e., ratio of duration when a level of the pulse is high is 50%) and phases that shift relative to each other by 90 degrees, as shown in the timing chart in FIG. 2. The encoded pulse FG1 is generated based on signals from predetermined two receiving sections 281 within the four sections. The encoded pulse FG2 is generated based on signals from two receiving sections 281 remaining within the four sections. Both the encoded pulses FG1 and FG2 are supplied to the gate IC 18. (Hereinafter, the encoded pulses FG1 and FG2 will be referred to as “pulse A and pulse B,” respectively.)

When the LED head 22 moves in a predetermined direction, the phase of the encoded pulse FG1 leads to the phase of the encoded pulse FG2 by 90 degrees; and when the LED head 22 moves in a corresponding reverse direction, the phase of the encoded pulse FG1 lags 90 degrees behind the phase of the encoded pulse FG2.

As shown in the timing chart in FIG. 2, the gate IC 18 latches a level of the encoded pulse FG2 at a rising edge of the encoded pulse FG1 input by the sensor 28, and then outputs an LR signal to the microcomputer 16.

A duration when pulse widths of both the encoded pulses FG1 and FG2 in FIG. 2 are long is a duration when the LED 22 is reversed (a turnback period). Namely, the direction of movement of the LED head 22 is switched (reversed) in the turnback period.

A reference pulse signal α that is a reference of a printing position (a position of the LED head 22) is generated in the printer 10 by changing resolutions of the encoded pulses FG1 and FG2.

In the present invention, one cycle of the reference pulse signal α, which is the combined period of the duration of a high level (H) and the duration of a low level (L), corresponds to a time required for scanning (or moving over) two dots of an image (i.e., twice the pitch existing between two adjacent dots) in the main scanning direction of an image. However, one cycle of the reference pulse signal α is not limited to this value, and may correspond to a time required for scanning one dot of an image, for example.

Further, a signal LR_N is generated in the printer 10 based on the LR signal and the encoded pulses FG1 and FG2.

One cycle of the LR_N signal, which is the combined period of the duration of a high level and the duration of a low level, corresponds to a time required for scanning (feeding) dots corresponding to two lines of an image (i.e., twice the pitch existing between two adjacent dots) in the sub scanning direction.

The direction of movement of the LED head 22 is detectable (distinguished) by using the LR_N signal. Namely, when a level of the LR_N signal is low, a direction of movement of the LED head 22 is determined to be in a certain direction (for example, to the right of the LED head 22, as shown in FIG. 3). Conversely, when a level of the LR_N signal is high, movement in a reverse direction is determined (for example, to the left of the LED head 22).

A position of the LED head 22 when a level of the LR_N signal is switched is detected as a turnback point of the LED head 22 in the printer 10.

An operation of generating the LR_N signal and the reference pulse signal α will be described later.

The LR_N signal and the reference pulse signal α of the printing position mentioned above are supplied to the microcomputer 16.

The microcomputer 16 detects a direction in which the LED head 22 is moving, and also a position (coordinate position) of both main and sub scanning directions of the LED head 22 (i.e. an area of the LED head 22) based on the LR_N signal and the reference pulse signal α. In this case, the microcomputer 16 detects a direction in which the LED head 22 is moving, on the basis of the LR_N signal.

Further, the microcomputer 16 sequentially detects (calculates) the coordinate positions of the plurality of LEDs mounted on the LED head 22 in the main and sub scanning directions by counting the number of pulses of the encoded pulse FG1 and the LR signal.

In fact, the microcomputer 16 counts a number of high and low levels of the reference pulse signal α, and sequentially detects the positions of the plurality of LEDs mounted on the LED head 22 in the main scanning direction based on the count value. The microcomputer 16 also counts a number of high and low levels of the LR_N signal, and sequentially detects the positions of the plurality of LEDs mounted on the LED head 22 in the sub scanning direction based on the count value. When counting the number of the reference pulse signal α, the microcomputer 16 counts up when a level of the LR_N signal is low, i.e., when the direction of movement of LED head 22 is a given direction, and counts down when a level of the LR_N signal is high, i.e., when the direction of movement of the LED head 22 is a direction reverse to the given direction. In addition, the count value of the reference pulse signal α indicates a position (printing position) of the LED head 22 in the main scanning direction, and the count value of the LR_N signal indicates a position (printing position) of the LED head 22 in the sub scanning direction.

The microcomputer 16 also sequentially reads out from the memory 14 image data corresponding to the calculated coordinate positions of the plurality of LEDs, and supplies the image data and the address data indicating the LED corresponding to the image data to the gate IC 18 to thereby set the image data in a first group of registers, as mentioned hereinafter.

While in the present embodiment, the printer 10 is configured such that the microcomputer 16 calculates the coordinate positions of the plurality of LEDs, so as to manage image data, it will be apparent to those skilled in the art that the present invention is in no way limited thereto. For example, the printer 10 of the present invention may include a computing device for calculating coordinate positions and setting image data in a first group of registers.

While the microcomputer 16 uses sequential processing, a computing device may be employed that uses parallel processing, whereby all coordinate positions of the plurality of LEDs can be calculated at high speed. By employing such a computing device a printer can be provided that is able to rapidly calculate coordinate positions in a short time. Consequently, the microcomputer 16 is not required to have a high processing speed, and inexpensive microcomputers having a relatively low processing speed can be utilized, thereby reducing a cost of the printer 10. Further, in a printer having such a computing device, since the LED head 22 can be moved more rapidly, a number of LEDs mounted on the LED head 22 can be increased, thereby enabling printing at a higher resolution (printing resolution) to be carried out in a relatively short period of time.

Such a computing device may be provided either separately from or integral to the gate IC 18.

In the printer 10 shown in FIG. 1, following exposure and development of ink, the heater 32 is used to heat a sheet of printing paper to harden the ink (image). The microcomputer 16 controls, via the heater driver 30, operations of the heater 32 (e.g., timing of heating).

Next, a structure of the LED head 22 in the printer 10 will be described. FIG. 3 is a bottom plan view illustrating an example of a structure of the LED head.

As shown in FIG. 3, in the present embodiment the LED head 22 comprises a head base 221, on which a total of nine LEDs (R1-R3, G1-G3, and B1-B3)are provided. The nine LEDs include three LEDs R1-R3 for emitting red light, three LEDs G1-G3 for emitting green light, and three LEDs B1-B3 for emitting blue light.

As shown in FIG. 3, the nine LEDs are provided in a form of a 3×3 matrix (tri-diagonal matrix) on the head base 221, and are arranged so as to be offset from each other by a predetermined number of dots in both a main and a sub scanning direction.

Namely, the LEDs R3, B3, and G3 of FIG. 3 are arranged in a top row of the matrix so as to be offset respectively by a predetermined number of dots in a vertical direction (sub scanning direction). In a case that in the structure shown in FIG. 3 the LED G3 is placed in a central vertical position relative to the LEDs of the top row of the matrix, the LED R3 is placed at a position above the LED G3, corresponding to a predetermined number of dots; and the LED B3 is placed at a position below the LED G3, corresponding to a predetermined number of dots.

Further, as shown in FIG. 3, LEDs R2, B2, and G2 are arranged in order in the middle row of the matrix so that they are offset respectively by a predetermined number of dots in the vertical direction, in the same manner as is utilized for the top row. Moreover, as is also shown in FIG. 3, LEDs R1, B1, and G1 are arranged in order in the bottom row of the matrix so that they are offset by a predetermined number of dots in the vertical direction, in the same manner as is utilized for the top and middle rows.

Further, as shown in FIG. 3, the LEDs R3, R2, and R1 are arranged in order in the right column of the matrix so that they are offset by a predetermined number of dots in the left-right direction (the main scanning direction). With regard to the structure shown in FIG. 3, the LED R2 occupies a central position in the horizontal direction in the right column of the matrix, the LED R1 is placed to the left of the LED R2 by a predetermined number of dots, and the LED R3 is placed to the right of the LED R2 by a predetermined number of dots.

Moreover, as shown in FIG. 3, the LEDs B3, B2, and B1 are arranged in order in the middle column of the matrix so that they are offset by a predetermined number of dots in the left-right direction, in the same manner as the right column. Similarly, as shown in FIG. 3, the LEDs G3, G2, and G1 are arranged in the left column of the matrix so that they are offset in order by a predetermined number of dots in the left-right direction in the same manner as the middle and right columns.

As mentioned above, the printer 10 of the present embodiment causes the LED head 22 to move in the main scanning direction, and causes the printing paper to move in the sub scanning direction. In this case, a latent image is recorded on a photosensitive printing paper by sequentially emitting light for each color corresponding to image data for a required time corresponding to image data onto the photosensitive printing paper by means of the nine LEDs R1-R3, G1-G3, and B1-B3 mounted on the LED head 22 and thereby two-dimensionally exposing the photosensitive printing paper.

In other words, a latent image corresponding to image data is recorded on each dot of the printing paper by sequentially emitting light from each of the LEDs R1-R3, G1-G3, and B1-B3 mounted on the LED head 22. In this regard, it is to be noted that the image data that is set in each of the three LEDs R1-R3 is identical for each dot (the same image data is set in each of the three LEDs R1-R3). Similarly, for each dot, the image data that is set in each of the three LEDs G1-G3 is identical, and the image data that is set in each of the three LEDs B1-B3 is identical.

Here, as shown in FIG. 3, since each of the LEDs is offset relative to one another in the sub scanning direction in the LED head 22, a time interval exists between the exposure of red light by means of the LED R3 and the exposure of green light by means of the LED G3, which corresponds to a time when the LED head 22 moves more than a predetermined number of lines. Also, a time interval exists between the exposure of green light by means of the LED G3 and the exposure of blue light by means of the LED B3, which corresponds to a time when the LED head 22 moves more than a predetermined number of lines.

Sensitivity of photosensitive microcapsules coated on a printing paper can be enhanced by exposing them to light emissions at regular intervals rather than to continuous light emission. Thus, by offsetting the positions of the LEDs in the sub scanning direction as in the LED head 22 shown in FIG. 3, sensitivity of microcapsules coated on a printing paper can be enhanced.

It is to be noted that an arrangement of LEDs relative to one another (spacing or shift-length) is not limited to that described above, and may be modified as required.

On the head base 221 the pressure mechanism 222 is provided, which acts to mechanically exert a pressure on an exposed printing paper to thereby develop an image (developing process). As shown in FIG. 3, the pressure mechanism 222 is provided at a position lower than that of the head base 221.

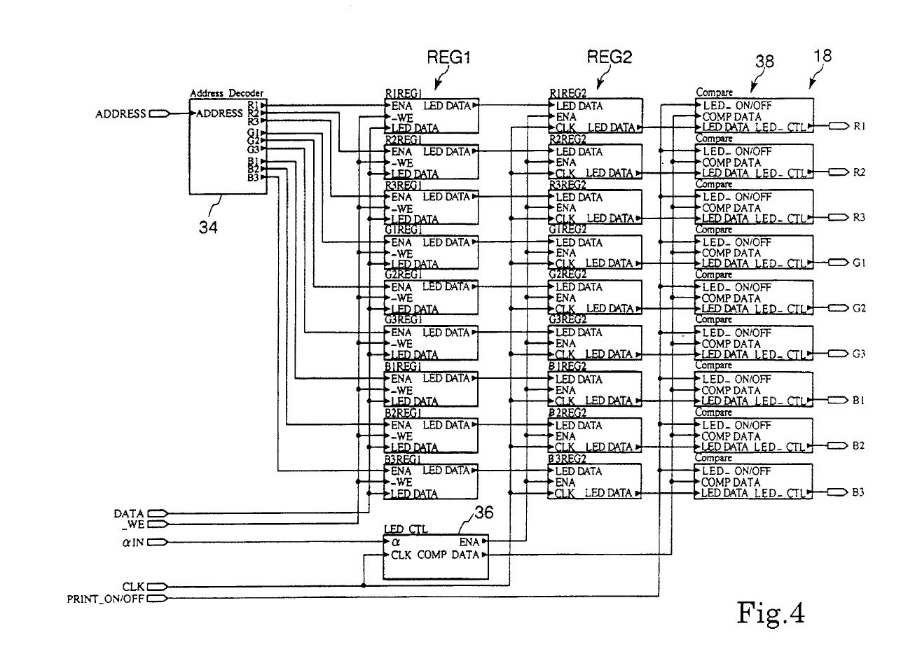

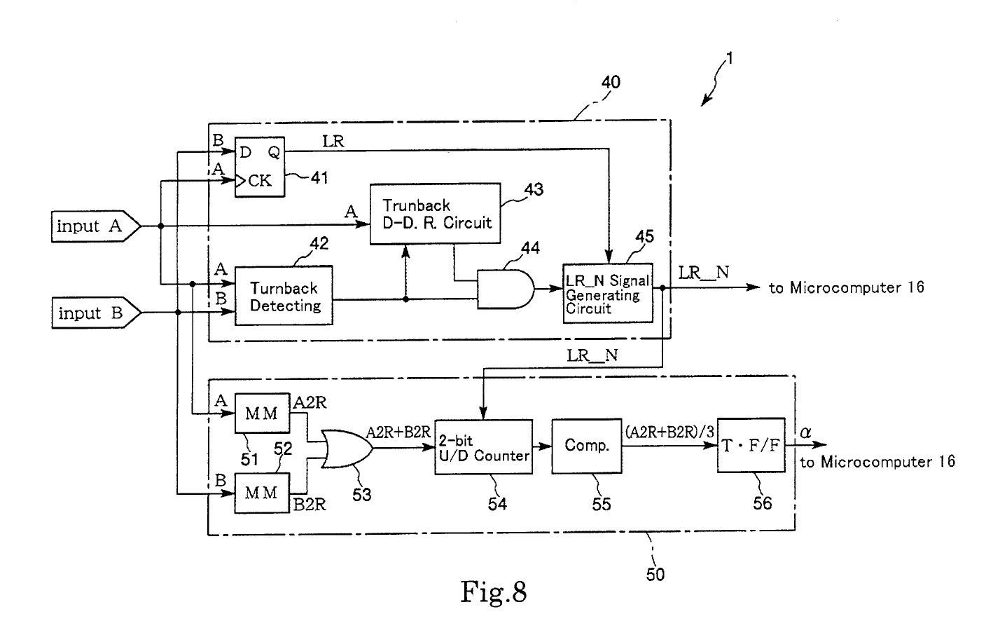

Next, an internal structure of the gate IC 18 in the printer 10 will be described. FIGS. 4 and 8 are block diagrams illustrating an example of the structure of a principal part of the gate IC 18 in the printer 10 shown in FIG. 1.

The parts that control the LED driver 20 within the gate IC 18 are shown in FIG. 4. As shown in FIG. 4, the gate IC 18 comprises an address decoder 34; an LED control circuit 36; a first group of registers REG1; a second group of registers REG2; and a group of comparators 38. Further, the parts, which set a printing resolution (resolution of an image) in the gate IC 18, are shown in FIG. 8. This structure will be described later. For the sake of simplicity, components of the gate IC 18 other than those described above are omitted in the following explanation.

As shown in Fig, 4, the microcomputer 16 inputs image data “LED DATA” to the first group of registers REG1 via a data bus “DATA.” The microcomputer 16 also inputs an address signal that specifies the LED (i.e., a first register) corresponding to the image data “LED DATA” to the address decoder 34 via an address bus “ADDRESS.”

The address decoder 34 decodes the address signal input by the microcomputer 16 via the address bus “ADDRESS,” and outputs an enable signal “ENA” to designate (select) a first register corresponding to the address signal in the first group of registers REG1.

The register designated by the “ENA” fetches and latches “LED DATA” output at this stage to the data bus “DATA”.

The LED control circuit 36 generates the enable signal “ENA” and comparative data “COMP DATA” based on the reference pulse signal α, and outputs them to the second group of registers REG2 and the group of comparators 38, respectively.

The enable signal “ENA” output from the LED control circuit 36 is a timing signal used to hold the image data “LED DATA,” which is set in the first group of registers REG1 and then transferred from the first group of registers REG1 to the second group of registers REG2 in parallel. The “ENA” is output at a predetermined timing after exposure of nine dots at a position of an immediately preceding dot is completed.

Further, the comparative data “COMP DATA” is utilized to determine timings when the nine LEDs R1-R3, G1-G3, and B1-B3 emit light, by comparing the comparative data “COMP DATA” with the image data “LED DATA,” which data is held in the second group of registers REG2. The comparative data “COMP DATA” is generated by counting clock signals “CLK” in synchronization with the reference pulse signal α, and is output to the group of comparators 38.

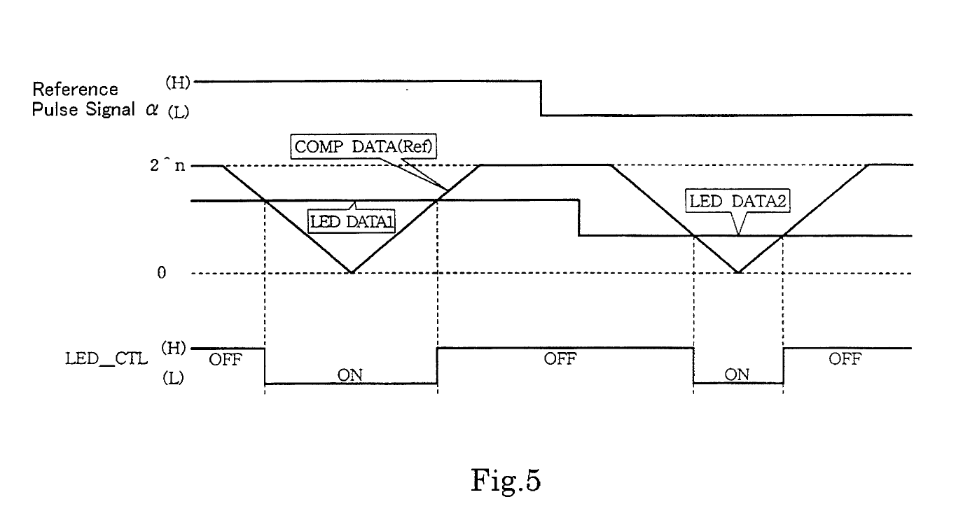

For example, as shown in the timing chart in FIG. 5, an n-bit counter is used to generate the comparative data “COMP DATA.” The counter is synchronized with the reference pulse signal α and repeats a countdown from (2ˆ n)−1 to 0 and a count-up from 0 to (2ˆ n)−1 by turns. This down/up operation of the counter is expressed in the timing chart in FIG. 5 by a triangular waveform. It is to be noted that while in the present embodiment a value of n is equal to eight, a value of n is not limited to eight.

In addition, as mentioned above, since one cycle of the reference pulse signal α corresponds to a time required for moving over two dots of an image in the main scanning direction, the above-mentioned operation of the counter is carried out for both the duration when the level of the encoded pulse “FG” is high and the duration when the level of the encoded pulse “FG” is low.

The first group of registers REG1 and the second group of registers REG2 includes a number of registers equal to that of LEDs mounted on the LED head 22, respectively. Likewise, the group of comparators 38 includes a number of comparators equal to that of LEDs mounted on the LED head 22. In the present embodiment, since a total of nine LEDs including three R-LEDs, three G-LEDs and three B-LEDs are mounted on the LED head 22, the first group of registers REG1 includes nine first registers, and the second group of registers REG2 includes nine second registers. Also, the group of comparators 38 includes nine comparators “Compare.”

The first group of registers REG1 is used to set the image data “LED DATA” corresponding to each of the LEDs R1-R3, G1-G3, and B1-B3 that are mounted on the LED head 22. The image data “LED DATA” is sent from the microcomputer 16 to the gate IC 18 via the data bus “DATA.”

As mentioned above, the first group of registers REG1 includes nine first registers; while in FIG. 4, the group includes: the first registers R1REG1, R2REG1, and R3REG1 to hold the image data “LED DATA” corresponding to three LEDs R1, R2, and R3 for emitting red light; the first registers G1REG1, G2REG1, and G3REG1 to hold the image data “LED DATA” corresponding to three LEDs G1, G2, and G3 for emitting green light; and the first registers B1REG1, B2REG1, and B3REG1 to hold the image data “LED DATA” corresponding to three LEDs B1, B2, and B3 for emitting blue light.

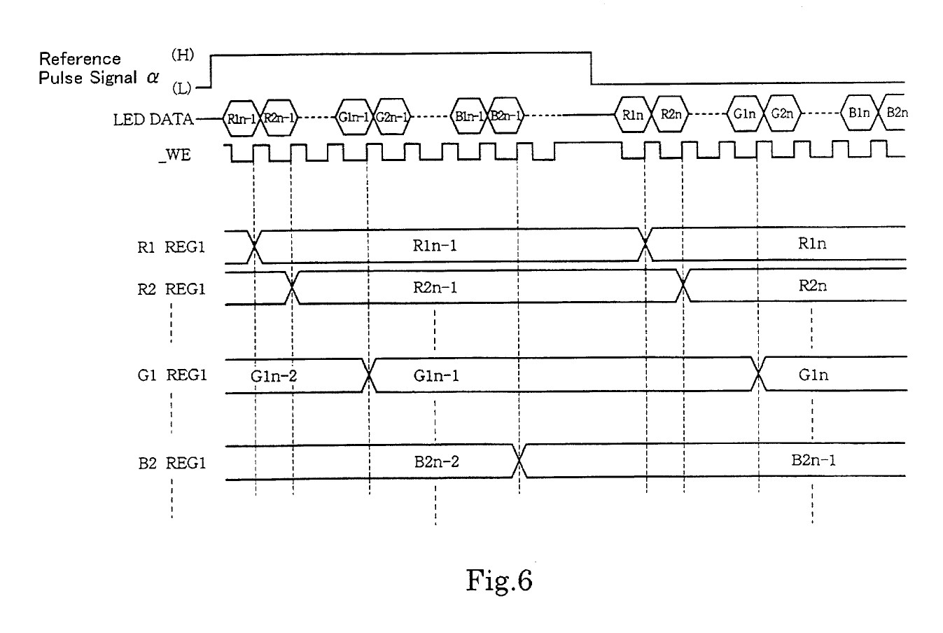

In the first group of registers REG1, as shown in the timing chart in FIG. 6, the image data “LED DATA” corresponding to nine LEDs R1-R3, G1-G3, and B1-B3 is sequentially set in the first register selected by the enable signal “ENA” in synchronization with both the reference pulse signal α and the rising edge of a write enable signal “_WE,” which is input by the microcomputer 16.

In this way, image data “LED DATA” corresponding to a total of nine LEDs R1-R3, G1-G3, and B1-B3 mounted on the LED head 22 is sequentially set in the first registers R1REG1-R3REG1, G1REG1-G3REG1, and B1REG1-B3REG1 by means of the microcomputer 16.

In addition, as mentioned above, since one cycle of the reference pulse signal α corresponds to a time required for moving over two dots of the image in the main scanning direction, the setup of the image data from the microcomputer 16 to the first group of registers REG1 is carried out for both a duration when the level of the reference pulse signal α is high and a duration when the level of the reference pulse signal α is low.

On the other hand, the second group of registers REG2 is used to hold the image data “LED DATA” corresponding to each of the nine LEDs R1-R3, G1-G3, and B1-B3 in parallel, which has been sequentially set in the first group of registers REG1.

The second group of registers REG2 includes nine second registers as mentioned above. In FIG. 4, they include the second registers R1REG2, R2REG2, and R3REG2 to hold the image data “LED DATA” corresponding to three LEDs R1, R2, and R3 for emitting red light; the second registers G1REG2, G2REG2, and G3REG2 to hold the image data “LED DATA” corresponding to three LEDs G1, G2, and G3 for emitting green light; and the second registers B1REG2, B2REG2, and B3REG2 to hold the image data “LED DATA” corresponding to three LEDs B1, B2, and B3 for emitting blue light.

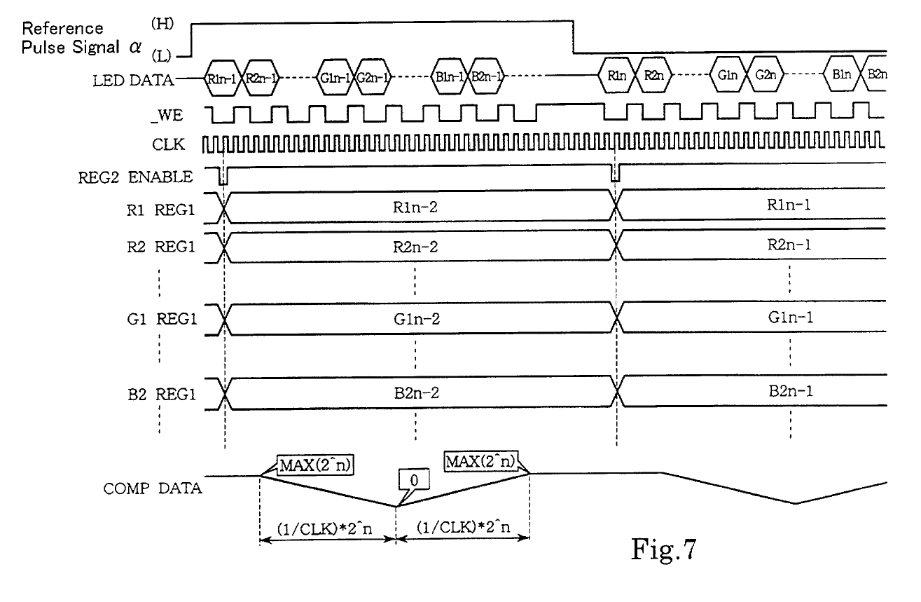

In the second group of registers REG2, as shown in the timing chart in FIG. 7, the image data “LED DATA” corresponding to nine LEDs R1-R3, G1-G3, and B1-B3, which was set in the first group of registers REG1, is held (shifted) in parallel by being synchronized with the reference pulse signal α, and being synchronized with the rising edge of the clock signal “CLK” sent from the oscillator 12 while the level of the enable signal “ENA” is low.

Namely, the image data “LED DATA” corresponding to the total of nine LEDs R1-R3, G1-G3, and B1-B3, which was respectively set in the first group of registers R1REG1-R3REG1, G1REG1-G3REG1, and B1REG1-B3REG1, is held in the second group of registers R1REG2-R3REG2, G1REG2-G3REG2, and B1REG2-B3REG2 in parallel.

As mentioned above, since one cycle of the reference pulse signal a corresponds to a time required for moving over two dots of the image in the main scanning direction, the transfer (shift) of the image data from the first group of registers REG1 to the second group of registers REG2 is carried out for a duration when a level of the reference pulse signal α is high and when a level of the reference pulse signal α is low.

As can be seen from the timing charts in FIGS. 6 and 7, the setting of the image data from the microcomputer 16 in the first group of registers REG1 is carried out in parallel with holding of the image data in the second group of registers REG2, and emission of the LEDs (exposure to a printing paper).

Concretely, the image data for the (n−2 )^{th} exposure is held in the second group of registers REG2, and the image data for the (n−1)^{th} exposure (next exposure) is set in the first group of registers REG1 by the microcomputer 16 while the (n−2)^{th} exposure is carried out on the basis of the image data for the (n−2)^{th} exposure.

After setting of the image data and exposure are completed, the image data set in the first group of registers REG1 is transferred to the second group of registers REG2, and held in the second group of registers REG2.

The (n−1)^{th} exposure and the setup of the image data for the n^{th} exposure to the first group of registers REG1 by means of the microcomputer 16 are then carried out. Subsequently, the operations mentioned above are repeated.

In this way, since the printer 10 has the second group of registers REG2, the data held in the first group of registers REG1 can be held in the second group of registers REG2 at the transition of the reference pulse signal α. Therefore, since the image data held in the second group of registers REG2 is used for driving LEDs, the microcomputer 16 can set subsequent image data in the first group of registers REG1 after detecting the transition of the reference pulse signal α.

Namely, since the printer 10 has a structure such that the first group of registers REG1 for setting the image data and the second group of registers REG2 for driving the LEDs are separated, the printer 10 need only set the subsequent image data while exposing one dot (during one exposure). Therefore, even if an inexpensive microcomputer with a low processing speed is used as the microcomputer 16, so long as a reasonable memory capacity is available, it is possible to set a plurality of image data to the LED head 22 reliably. Thus, the printer 10 can readily provide both high speed and high-resolution printing.

Next, each comparator “Compare” of the group of comparators 38 outputs to an LED driver 20 an LED control signal “LED_CTL” for controlling the LED driver 20.

In this case, a printing on/off signal “PRINT_ON/OFF” for switching between a printing state and a non-printing state is input by the microcomputer 16 to each comparator of the group of comparators 38, and the image data “LED DATA” is input by a corresponding second register in the second group of registers REG2 to each comparator of the group of comparators 38. The comparative data “COMP DATA” is also input by the LED control circuit 36 to each comparator of the group of comparators 38. Each comparator “Compare” compares the image data “LED DATA” held in the second group of registers REG2 with the comparative data “COMP DATA” input by the LED control circuit 36, and outputs an LED control signal “LED_CTL” for controlling the LED driver 20 on the basis of a comparative result and “PRINT_ON/OFF” signal received from the microcomputer 16.

As shown in the timing chart in FIG. 5, the level of the LED control signal “LED_CTL” becomes low when the level of the image data “LED DATA” is higher than that of the comparative data “COMP DATA,” and also when the level of the “PRINT_ON/OFF” signal is low, which indicates that the printer 10 is in the printing state. The LEDs emit light when the level of the LED control signal “LED_CTL” is low.

In addition, the polarity of the LED control signal “LED_CTL” is not limited to either low or high. In contrast to the present embodiment, it should be noted that the LEDs are able to emit light when the level of the polarity of the LED control signal “LED_CTL” is high.

In the Cycolor type printer 10 of the present embodiment, a photosensitive printing paper is placed in proximate and opposing relation to the LED head 22. The printer 10 exposes the photosensitive printing paper by moving the LED head 22 in the main scanning direction, and simultaneously emits light with each color corresponding to the image data to the photosensitive printing paper. When the LED head 22 arrives at one end of the printing region in the photosensitive printing paper, the photosensitive printing paper is moved by a predetermined number of dots in the sub scanning direction. Then, the LED head 22 is moved in a reverse direction in the main scanning direction, and the printer 10 emits light with each color corresponding to the image data to the photosensitive printing paper. Subsequently, the operations mentioned above are repeated.

Thus, the photosensitive printing paper is two-dimensionally exposed by means of the LED head 22, whereby the latent image is recorded (formed) on the photosensitive printing paper.

In the exposure step, the encoded pulses FG1 and FG2 are generated by means of the encoder and the sensor 28, as the LED head 22 is moving. The reference pulse signal α and the LR_N signal are then generated on the basis of the encoded pulses FG1 and FG2 in the gate IC 18. The microcomputer 16 calculates coordinate positions of the nine LEDs R1-R3, G1-G3, and B1-B3, which are provided (mounted) on the LED head 22, on the basis of the reference pulse signal α and the LR_N signal. Then, the microcomputer 16 reads out image data corresponding to the calculated coordinate position of each of the LEDs R1-R3, G1-G3, and B1-B3 from the memory 14, and sequentially sets the image data read out from the memory 14 to the first group of registers REG1 in the gate IC 18.

In the development step, the portion in the photosensitive printing paper in which the exposure was completed is mechanically subject to pressure by being interposed between the pressure mechanism 222 and a pressed surface (not shown), whereby an image based on the image data in the memory 14 is developed. In this way, image data can be developed over the entire area of the photosensitive printing paper by simultaneously moving the LED head 22 in the main scanning direction and moving the photosensitive printing paper in the sub scanning direction.

In the development step, microcapsules that remain soft are crushed by the pressure mechanism 222 on the pressed surface, causing the ink in the crushed microcapsules to be released and mixed so that the photosensitive printing paper is colored in accordance with the image data, and a desired image is reproduced on the photosensitive printing paper.

Then, the developed printing paper is heated by means of the heater 32, to thereby fix the image on the printing paper. At this point, the printing process (printing job) is completed.

Next, a setting (adjustment) operation of a printing resolution of the printer 10 will be described.

The printer 10 can obtain a desired printing resolution by setting (adjusting) a frequency (resolution) of the reference pulse signal α that is a reference of the printing position (a position of the LED head 22).

In fact, the printer 10 of the present invention comprises head turnback position detecting means for detecting a turnback position (turnback time) of the LED head 22 based on the encoded pulses FG1 and FG2 supplied from the sensor 28, and pulse resolution changing means for changing the resolution of the encoded pulses FG1 and FG2 based on a detected result obtained by the head turnback position detecting means and generating a reference pulse signal α that is a reference of the printing position.

The pulse resolution changing means comprises: a-multiply pulse signal generating means (a-multiply pulse signal generating circuit) for generating an a-multiply pulse signal that are a (“a” is any one of two or more integral numbers.) times the encoded pulses FG1 and FG2 (in the present embodiment, four-multiply pulse signal generating circuit for generating a four-multiply pulse signal that are four times the encoded pulses FG1 and FG2); a counter; and a divider for dividing an a-multiply pulse signal (four-multiply pulse signal in the present embodiment) so that the reference pulse signal α becomes substantially symmetrical at the center of the actual turnback point of the LED head 22 on the basis of the detected result of the head turnback position detecting means.

The printer 10 generates the reference pulse signal α, the reference of the printing position, by changing resolutions (frequencies) of the encoded pulses FG1 and FG2 supplied from thee sensor 28.

In the present embodiment, a case in which a reference pulse signal α having two thirds of the frequencies (resolution) of encoded pulses FG1 and FG2 is generated from the encoded pulses FG1 and FG2, i.e., a printing resolution is set to two thirds of the printing resolution when directly using the encoded pulses FG1 and FG2 as the reference pulse signal of the printing position, will be described. The present invention is not limited to this case. Further, in the present invention, the resolution (frequency) of the reference pulse signal α may be set to be one either higher or lower than the resolution (frequency) of the encoded pulses FG1 and FG2.

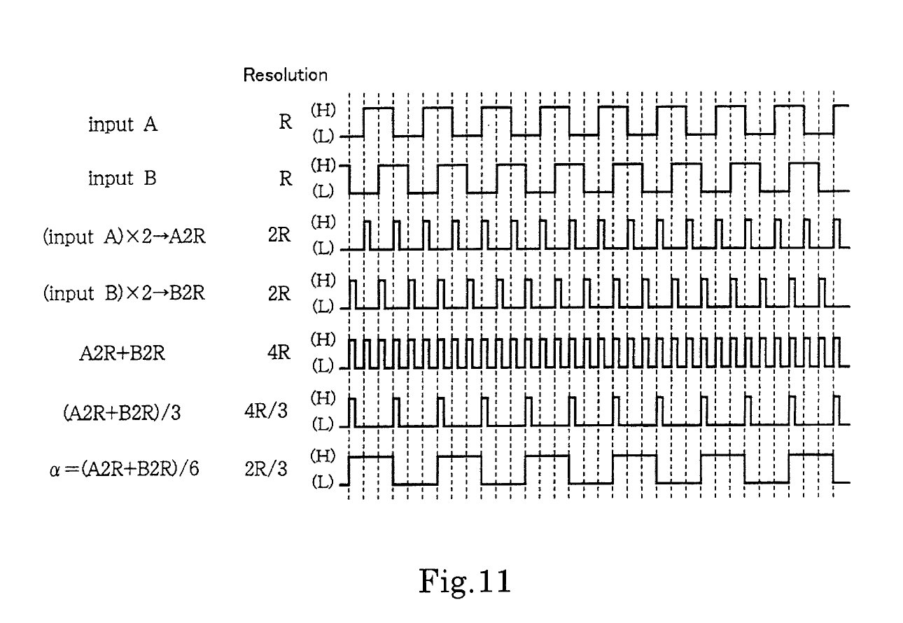

First, a general outline of the present invention will be described with reference to a timing chart shown in FIG. 11. Hereinafter, the encoded pulses FG1 and FG2 are referred to as “pulse A” and “pulse B,” respectively.

As shown in FIG. 11, a pulse A2R having a frequency twice that of a pulse A is generated based on the pulse A, and a pulse B2R having a frequency twice that of a pulse B is generated based on the pulse B. Similarly, a pulse A2R+B2R (four-multiply pulse signal) having a frequency twice that of the pulse A or the pulse B is generated based on the pulses A2R and B2R.

Then, the pulse A2R+B2R is divided so that a frequency of a pulse becomes a third one of the pulse A2R+B2R, thereby obtaining a pulse (A2R+B2R)/3. Further, the pulse (A2R+B2R)/3 is divided so that a frequency of a pulse becomes half that of the pulse (A2R+B2R)/3, thereby obtaining a pulse (A2R+B2R)/6 that has two thirds of frequencies (resolution) of the pulses A and B, i.e., a reference pulse signal α.

Further, an LR_N signal (a signal for detecting a direction of movement) is generated in the printer 10 based on an LR signal and pulses A and B. The LR_N signal is utilized when the pulse (A2R+B2R)/3 is generated by dividing the pulse A2R+B2R.

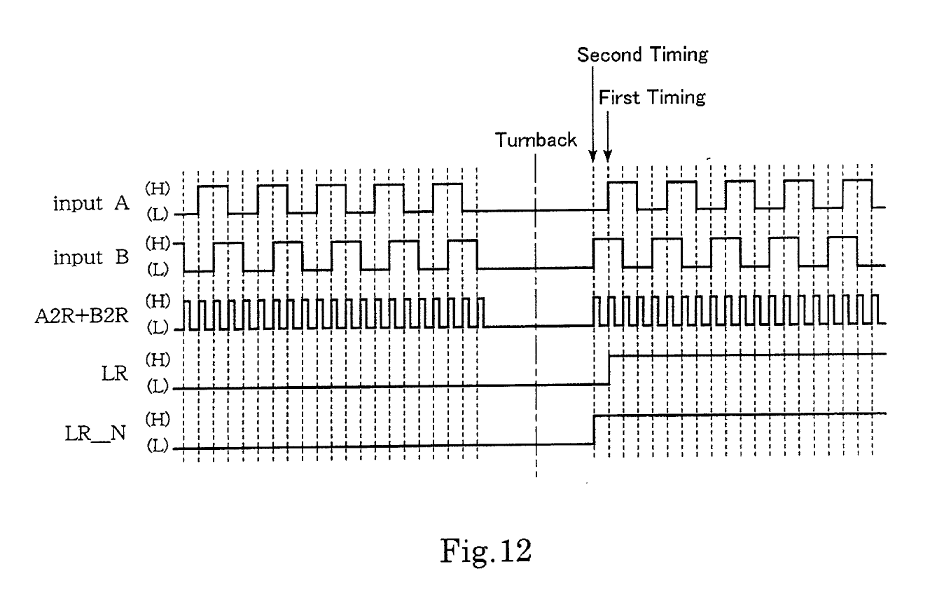

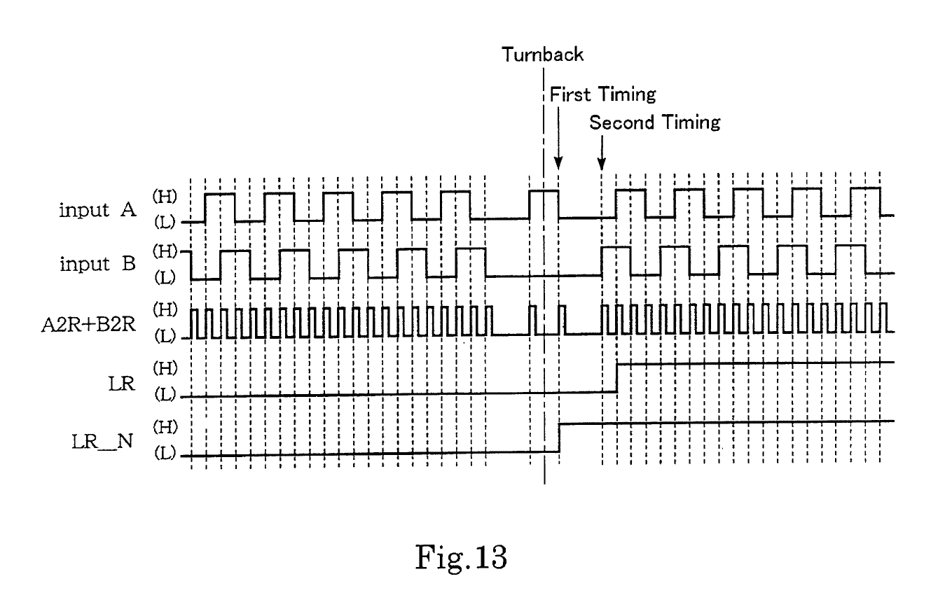

Namely, as shown in FIGS. 12 and 13, the LR_N signal is obtained by switching a level of the LR signal at a timing when a level of one of the pulses A and B changes twice with a level of another pulse being unchanged. A case in which an irregular pulse (abnormal pulse) is generated when the LED head 22 turns back is shown in FIG. 13.

In other words, the head turnback position detecting block 40 compares a level of the pulse B at a rising point of the pulse A with a level of the pulse B at a falling point of the pulse A, and determines a later timing in the rising and falling points of the pulse A as a first timing in a case that both levels are either high or low. The head turnback position detecting block 40 also compares a level of the pulse A at a rising point of the pulse B with a level of the pulse A at a falling point of the pulse B, and determines a later timing in the rising and falling points of the pulse B as a second timing in a case that both levels are either high or low. An LR_N signal is obtained by switching a level of the LR signal at an earlier timing in the first and second timing (i.e., a second timing in the example shown in FIG. 12, and a first timing in the example shown in FIG. 13).

The LED head 22 turns back at the earlier timing in the first and second timing (timing when the level of another pulse mentioned above changes twice), i.e., timing of switching the level of the LR_N signal.

The timing of switching the level of the LR_N signal slightly differs from an actual turnback point of the LED head 22. However, the pulse A2R+B2R can be exactly divided into parts before and after the actual turnback position of the LED head 22, and a proper reference pulse signal a can be obtained by handling the timing of switching the level of the LR_N signal as the turnback position of the LED head 22.

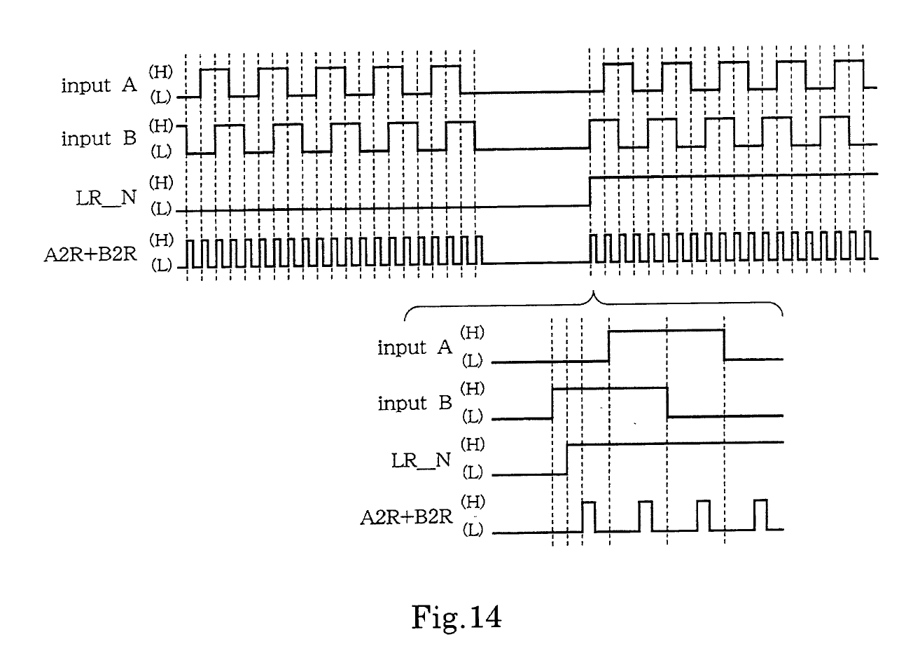

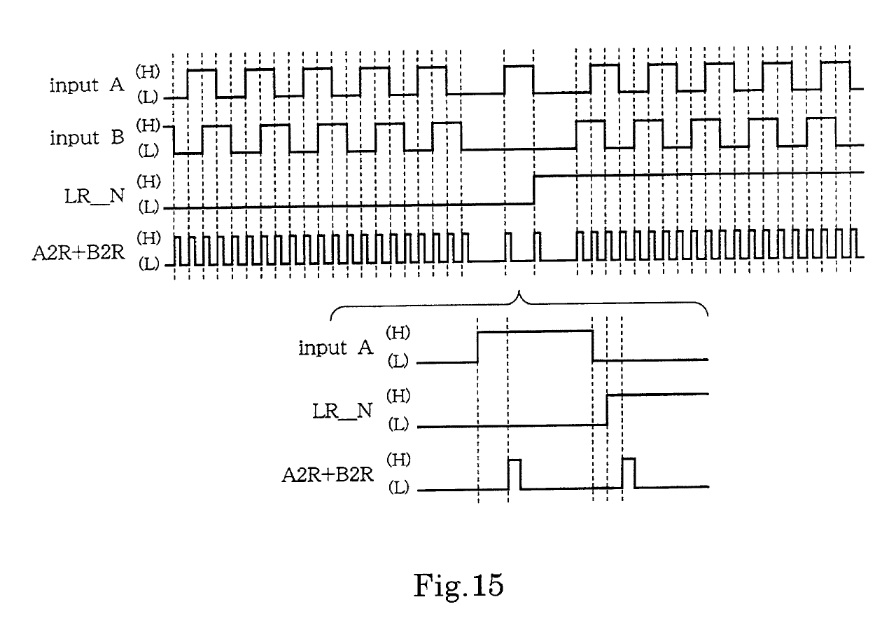

As shown in detail in FIGS. 14 and 15, a switch in the level of the LR_N signal is carried out with a delay for a predetermined short time from a timing when a level of one of the pulses A and B changes twice with a level of the other pulse remaining unchanged (an earlier timing in the first and second timing). Further, the pulse A2R+B2R is generated with a delay for a predetermined short time from a switching timing of the LR_N signal. A circuit such as a delay circuit achieves (assures) the predetermined short time (delay time) and an order of delay.

Therefore, this delay operation mentioned above can prevent timing of a rising point of one pulse and timing of a falling point of other pulse from overlapping. Namely, since the pulse A2R+B2R is generated after detecting that a level of the LR_N signal is switched and thereby the LED head 22 turns back, a proper reference pulse signal α can be generated.

Next, a dividing operation will be described. In the printer 10, a dividing operation is carried out by a divider having a counter. The divider divides an a-multiply pulse signal so that a frequency of the divided pulse signal becomes n times (“n” is any one of two or more integral numbers.) that of the a-multiply pulse signal.

An up/down counter may be used as the counter of the divider. Preferably, an up/down counter with a data loading function may be used.

When an a-multiply pulse signal is divided so that a frequency of the divided pulse signal becomes n times that of the a-multiply pulse signal, the divider counts up or down a number of pulses of the a-multiply pulse signal. In a count-up operation, if the divider counts to an n^{th} pulse, the divider starts to count up the pulses from “1” after the counting value is returned to “0.” Further, in a countdown operation, if the divider counts to an n^{th} pulse, the divider starts to count down the pulses from “n−2” after the counting value is returned to “n−1.” In both count-up and countdown operations, a pulse is generated in synchronization with n^{th} count. If a turnback position of the LED head 22 is detected by means of the head turnback position detecting means, the operation is switched between a count-up operation and a countdown operation.

The pulse divided in the above-mentioned way becomes symmetrical at the center of the actual turnback point of the LED head 22 regardless of a number of the pulses A and B generated in one line, and also even in a case that an irregular pulse (abnormal pulse) is generated when the LED head 22 turns back.

If the n is 2^{b}−1, i.e., if an a-multiply pulse signal is divided so that a frequency of the divided pulse signal becomes a (2^{b}−1)^{th} that of the a-multiply pulse signal, it is preferred that a b-bit up/down counter is used as a counter of the divider, more especially a b-bit up/down counter with a data loading function is preferably used.

In this case, both the counting value of n^{th} count in the count-up operation and the counting value of n^{th} count in the countdown operation are set to “n.”

Namely, in the count-up operation, when the counting value becomes “n,” a pulse is generated and the counting value is returned to “0” to start to count up from “1.” Also, in the countdown operation, when the counting value becomes “n,” a pulse is generated and the counting value is returned to “n−1” to start to count down from “n−2.”

Thus, a circuit for generating a pulse when a counting value becomes n can be shared in the count-up operation and the countdown operation, whereby a structure of the circuit can be simplified (components of the circuit can be reduced) and a production cost can be reduced.

The divider generates a reference pulse signal α of the printing position by dividing an a-multiply pulse signal so that a frequency of the divided pulse signal becomes n times that of the a-multiply pulse signal and further dividing the divided pulse signal. Since the pulse to be divided already becomes symmetrical at the center of the actual turnback position of the LED head 22 in this dividing operation, a reference pulse signal a symmetrical at the center of the actual turnback position of the LED head 22 can be obtained by carrying out dividing only.

A duty ratio (ratio of a duration when a level of the reference pulse signal α is high in one cycle) of the pulse of this reference pulse signal α is preferably 50%.

Here, in the present embodiment, the pulse A2R+B2R is divided so that a frequency of the divided pulse signal becomes a third that of the pulse A2R+B2R (four-multiply pulse signal) (i.e., a=4 and n=3). As mentioned above, it is preferred that a 2-bit up/down counter with a data loading function (upper and lower limits of the counting value are 3 and 0, respectively) is used as a counter of the divider.

The 2-bit up/down counter operates a counting value as “0-1-2-3-0-1-2-3-0 . . . ” in the count-up operation, and as “3-2-1-0-3-2-1-0-3 . . . ” in the countdown operation.

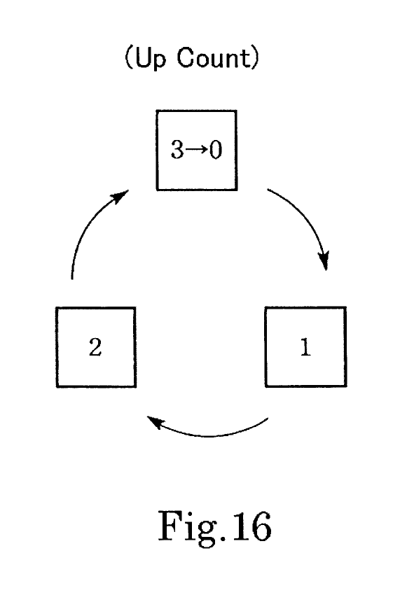

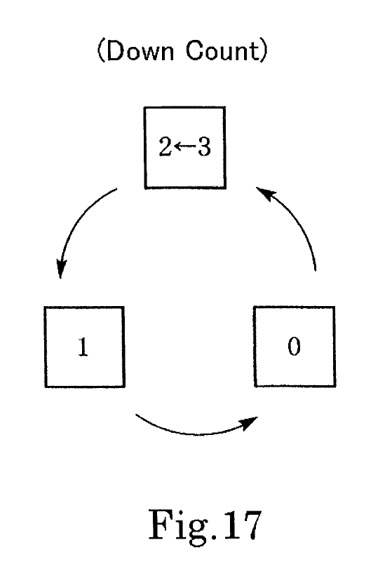

In the present embodiment, when the pulse A2R+B2R (four-multiply pulse signal) is divided so that a frequency of the divided pulse signal becomes a third that of the pulse A2R+B2R, the divider counts up or down the pulse A2R+B2R. In a case of the count-up operation, as shown in FIG. 16, when the divider counts up to “3,” the counting value is returned to “0” to start to count up from “1.” In a case of the countdown operation, as shown in FIG. 17, when the divider counts down to “3,” the counting value is returned to “2” to start to count down from “1.” A pulse is generated in synchronization with a count of “3” in both the count-up and countdown operation. When a turnback position of the LED head 22 is detected based on a switch in a level of the LR_N signal, the divider carries out the above-mentioned dividing operation by switching between count-up and countdown.

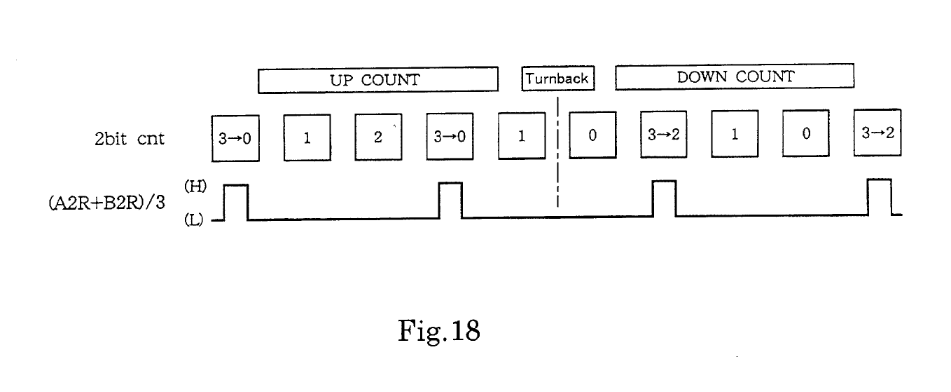

Namely, in the present embodiment, when switching from a count-up operation to a countdown operation, as shown in FIG. 18, the pulse A2R+B2R is counted up first. Then, a pulse (A2R+B2R)/3 is generated in synchronization with a count of “3,” and a count of “0” is loaded as a counting value to start to count up from “1.” When the turnback position of the LED head 22 is detected based on switch of a level of the LR_N signal, the operations switches from the count-up operation to the countdown operation. In the example shown in FIG. 18, when the pulse A2R+B2R is counted up to “1,” the LED head 22 turns back, and the countdown operation starts from “0.” Then, the pulse (A2R+B2R)/3 is generated in synchronization with a count of “3,” and a count of “2” is loaded as a counting value to start to count down from “1.”

As shown in FIG. 18, the pulse (A2R+B2R)/3 generated as mentioned above becomes symmetrical at the center of the actual turnback position of the LED head 22.

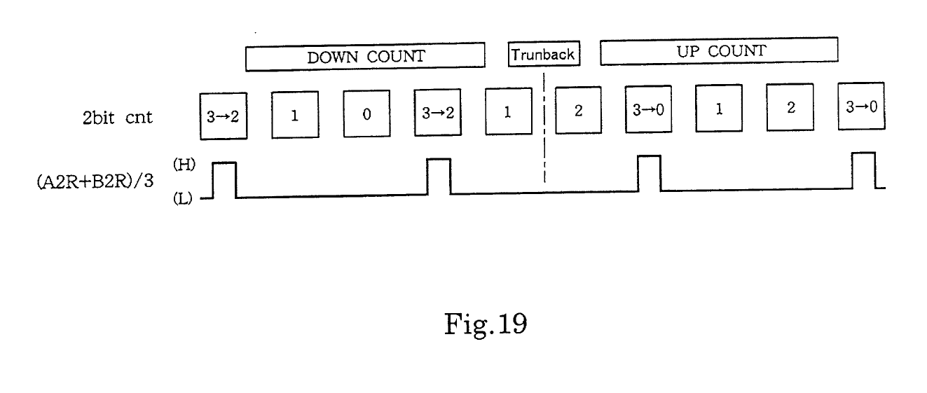

On the other hand, when switching from a countdown operation to a count-up operation, as shown in FIG. 19, the pulse A2R+B2R is counted down first. Then, a pulse (A2R+B2R)/3 is generated in synchronization with a count of “3,” and a count of “2” is loaded as a counting value to start to count down from “1.” When the turnback position of the LED head 22 is detected based on switch of a level of the LR_N signal, the operation switches from the a countdown operation to a count-up operation. In the example shown in FIG. 19, when the pulse A2R+B2R is counted down to “1,” the LED head 22 turns back, and the countdown operation starts from “2.” Then, the pulse (A2R+B2R)/3 is generated in synchronization with a count of “3,” and a count of “0” is loaded as a counting value to start to count down from “1.”

As shown in FIG. 19, the pulse (A2R+B2R)/3 generated as mentioned above becomes symmetrical at the center of the actual turnback position of the LED head 22.

Further, the divider divides the pulse (A2R+B2R)/3 so that a frequency of the divided pulse becomes a half that of the pulse (A2R+B2R)/3, whereby a pulse (A2R+B2R)/6, i.e., a reference pulse signal α, is generated, which has a resolution (frequency) that is two thirds that of the pulses A and B and a duty ratio of 50%.

The reference pulse signal α generated as mentioned above becomes symmetrical at the center of the actual turnback position of the LED head 22.

It is to be noted that a counter used in the present invention is not limited to one mentioned above, and 3 or more bit up/down counter may be utilized.

Next, a circuit for generating a reference pulse signal α, which is a reference of a printing position (a position of the LED head 22) of the printer 10, and an LR_N signal will be described with reference to the block diagrams shown in FIGS. 8-10.

FIG. 8 is a block diagram illustrating an example of a structure of a pulse resolution converting circuit (pulse resolution converting means) 1, which is one principal part of gate IC 18 in the printer 10.

The pulse resolution converting circuit 1 is a part of the gate IC 18, and is a circuit for generating a reference pulse signal α that is a reference of the printing position (position of the LED head 22) by changing resolutions (frequencies) of encoded pulses FG1 (A) and FG2 (B). Namely, the pulse resolution converting circuit 1 is a circuit for setting (adjusting) a printing resolution of the printer 10. The pulse resolution converting circuit 1 comprises a head turnback position detecting block (head turnback position detecting means) 40 and a pulse dividing block 50.

The head turnback position detecting block 40 comprises: a D flip-flop 41; a turnback detecting circuit 42; a turnback double-detecting prevention circuit 43; an AND circuit 44; and an LR_N signal generating circuit 45.

The pulse dividing block 50 comprises: a pair of mono multi-circuits 51 and 52; an OR circuit 53; an up/down counter 54; a comparator 55; and a T flip-flop 56.

As mentioned above, a 2-bit up/down counter with a data loading function is used as the up/down counter 54 in the present embodiment.

In addition, the pair of mono multi-circuits 51 and 52 and the OR circuit constitute a four-multiply pulse signal generating circuit (a-multiply pulse signal generating circuit) mentioned above. Further, the up/down counter 54, the comparator 55 and the T flip-flop 56 constitute a divider.

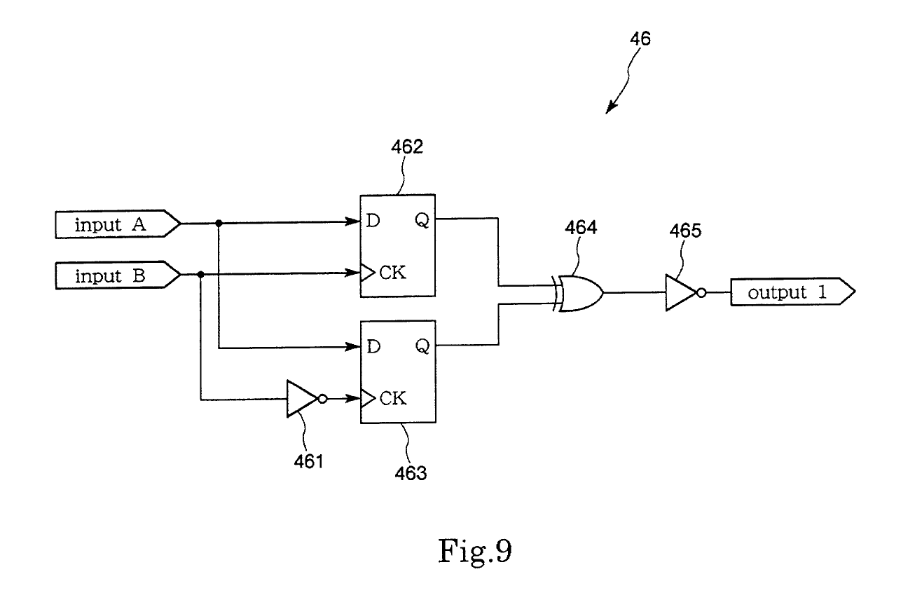

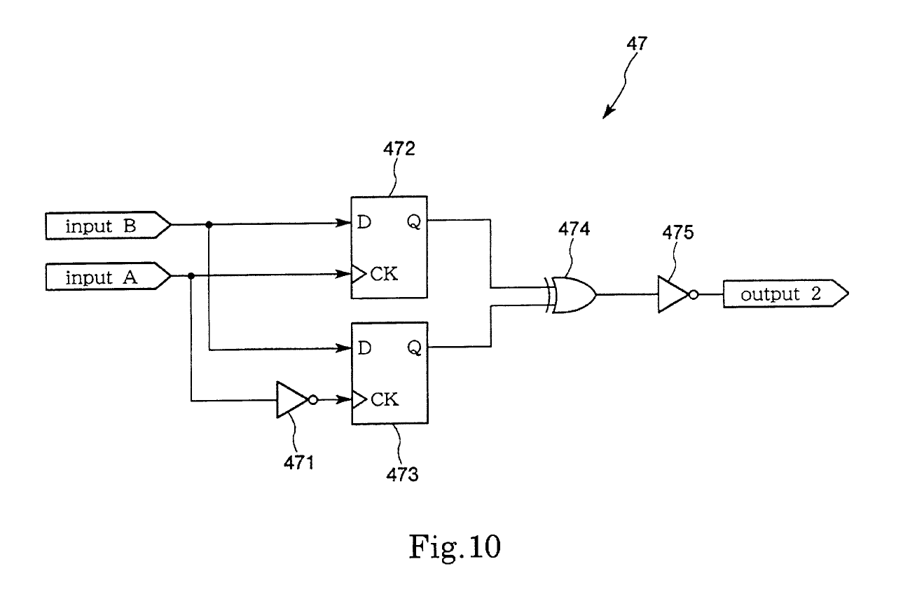

FIGS. 9 and 10 are block diagrams illustrating an example of a structure of the turnback detecting circuit 42 of the pulse resolution converting circuit 1 shown in FIG. 8. The turnback detecting circuit 42 comprises a first detecting circuit 46 shown in FIG. 9 and a second detecting circuit 47 shown in FIG. 10.

As shown in FIG. 9, the first detecting circuit 46 comprises: two NOT circuits 461 and 465; a pair of D flip-flops 462 and 463; and an exclusive OR circuit 464. As shown in FIG. 10, the second detecting circuit 46 also comprises: two NOT circuits 471 and 475; a pair of D flip-flops 472 and 473; and an exclusive OR circuit 474, as well as the first detecting circuit 46.

It is to be noted that, although the pulse resolution converting circuit 1 is a part of the gate IC 18 in the present invention, the present invention is not limited to such a structure, and the pulse resolution converting circuit 1 may be provided separately from the gate IC 18.

Next, operations of the pulse resolution converting circuit 1 will be described. As shown in FIG. 1, the encoded pulses FG1 (A) and FG2 (B) are supplied to the gate IC 18. Hereinafter, the encoded pulses FG1 and FG2 will be referred to as “pulse A and pulse B,” respectively.

As shown in FIG. 8, the pulse A is input to an input terminal CK of the D flip-flop 41, the turnback detecting circuit 42, the turnback double-detecting prevention circuit 43 and the mono multi-circuit 51, respectively. Further, the pulse B is input to an input terminal D of the D flip-flop 41, the turnback detecting circuit 42 and the mono multi-circuit 52, respectively.

As shown in the timing chart in FIG. 2, in the D flip-flop 41 a level of the pulse B is latched (held) at the rising point of the pulse A and the LR signal is output from an output terminal Q to the LR_N signal generating circuit 45.

As shown in FIG. 9, the pulse A is input to an input terminal D of the D flip-flop 462 in the first detecting circuit 46 and an input terminal D of the D flip-flop 463, respectively.

Further, the pulse B is input to an input terminal CK of the D flip-flop 462 in the first detecting circuit 46. A level of the pulse B is inverted (if its level is low or high, the level is converted to high or low, respectively) by means of the NOT circuit 461 and then input to an input terminal CK of the D flip-flop 463.

In the D flip-flop 462, a level of the pulse A is latched (held) at the rising point of the pulse B and the latched pulse (signal) is output from its output terminal Q to one input terminal of the exclusive OR circuit 464.

Similarly, in the D flip-flop 463, a level of the pulse A is latched (held) at the rising point of the pulse B and the latched pulse (signal) is output from its output terminal Q to the other input terminal of the exclusive OR circuit 464.

If levels of both the input pulses are equal, a low-level signal is output from the exclusive OR circuit 464. On the other hand, if levels of both the input pulses are not equal, a high-level signal is output from the exclusive OR circuit 464.

A level of the output pulse from the exclusive OR circuit 464 is inverted by means of the NOT circuit 465 and the inverted pulse is output as “output 1.”

As shown in FIG. 10, the pulse A is input to an input terminal CK of the D flip-flop 472 in the first detecting circuit 47. A level of the pulse A is inverted (if its level is low or high, the level is converted to high or low, respectively) by means of the NOT circuit 471 and then input to an input terminal CK of the D flip-flop 473.

Further, the pulse B is input to an input terminal D of the D flip-flop 472 in the first detecting circuit 47 and an input terminal D of the D flip-flop 473, respectively.

In the D flip-flop 472, a level of the pulse B is latched (held) at the rising point of the pulse A and the latched pulse (signal) is output from its output terminal Q to one input terminal of the exclusive OR circuit 474.

Similarly, in the D flip-flop 473, a level of the pulse B is latched (held) at the rising point of the pulse A and the latched pulse (signal) is output from its output terminal Q to the other input terminal of the exclusive OR circuit 474.

If levels of both the input pulses are equal, a low-level signal is output from the exclusive OR circuit 474. On the other hand, if levels of both the input pulses are not equal, a high-level signal is output from the exclusive OR circuit 474.

A level of the output pulse from the exclusive OR circuit 474 is inverted by means of the NOT circuit 475 and the inverted pulse is output to “output 2.”

A logical addition (OR) of the pulse (output 1) output from the first detecting circuit 46 and the pulse (output 2) output from the second detecting circuit 47 is output from the turnback detecting circuit 42. The pulse output from the turnback detecting circuit 42 is input to the turnback double-detecting prevention circuit 43 and one input terminal of the AND circuit 44, respectively. It is determined that a timing at a rising point of a first pulse output from the turnback detecting circuit 42 is a timing of the turnback position of the LED head 22.

A signal to be used for preventing double detection (duplicate detection) of the turnback position is output from the turnback double-detecting prevention circuit 43 to the other input terminal of the AND circuit 44.

In the turnback of the LED head 22, a level of the output signal from the turnback double-detecting prevention circuit 43 becomes low for a predetermined time until the LED head 22 moves by a predetermined distance away from the turnback position of the LED head 22 after the turnback of the LED head 22 is detected once (after a first pulse output from the turnback detecting circuit 42 is detected), and becomes high in the period other than the above-mentioned duration.

An output from the AND circuit 44 is always low, regardless of the level of the pulse output from the detecting circuit 42 while the level of the output signal from the turnback double-detecting prevention circuit 43 is low. On the other hand, an output of the AND circuit 44 becomes the same as a level of the pulse output level from the turnback detecting circuit 42 while the level of the output signal from the turnback double-detecting prevention circuit 43 is high.

Therefore, once the turnback of the LED head 22 is detected, a fault of double-detecting the turnback of the LED head 22 can be prevented for the predetermined period until the LED head 22 moves by the predetermined distance away from the turnback position.

In fact, the turnback double-detecting prevention circuit 43 sets a level of the output signal to high until a first pulse is input from the turnback detecting circuit 42. This setting is reset by receiving the first pulse input from the turnback detecting circuit 42, and the level of the output signal is set to low.

The pulse A is counted up after the reset operation in the turn double-detecting prevention circuit 43. When the counting value becomes a predetermined value, the level of the output signal is set to high. Alternatively, the pulse B may be counted up in this operation.

Only the first pulse input from the turnback detecting circuit 42 is output from the AND circuit 44 to the LR_N signal generating circuit 45 during the turnback of the LED head 22. In more detail, a timing of the first pulse input from the turnback detecting circuit 42 is the same as a timing of a rising point, and the pulse with a duration of the high level changed (reduced) is just output to the LR_N signal generating circuit 45.

A level of the LR signal input from the AND circuit 44 is switched in synchronization with a rising point of the pulse input from the AND circuit 44 (a rising point of the pulse that has an earlier rising point in the pulse output from the first detecting circuit 46 (output 1) and the pulse output from the second detecting circuit 47 (output 2). Namely, the LR signal having a low level is switched to a signal having a high level and vice versa, whereby an LR_N signal is generated. Therefore, the LR_N signal differs from the LR signal only at a point that the timing of switching its level is a timing of the rising point of the pulse input from the AND circuit 44. The LR_N signal is output from the LR_N signal generating circuit 45 for supply to the microcomputer 16 and the up/down counter 54.

On the other hand, pulses are generated in synchronization with a rising and falling point of the pulse A in the mono multi-circuit 51, whereby a pulse A2R having a frequency that is twice the frequency of the pulse A is obtained (see FIG. 11). The pulse A2R is output from the mono multi-circuit 51 for input to one terminal of the OR circuit 53.

Similarly, pulses are generated in synchronization with a rising and falling point of the pulse B in the mono multi-circuit 51, whereby a pulse B2R having a frequency that is twice the frequency of the pulse B is obtained (see FIG. 11). The pulse B2R is output from the mono multi-circuit 52 for input to another terminal of the OR circuit 53.

A pulse A2R+B2R (four-multiply pulse signal) having a frequency of four times that of the pulse A or B is generated in the OR circuit 53 on the basis of the pulses A2R and B2R (see FIG. 11) for input to the up/down counter 54.

A count-up operation or countdown operation of the pulse A2R+B2R is carried out in the up/down counter 54. This counting signal, i.e., counting value is input to the comparator 55.

As mentioned above, the up/down counter 54 starts to count up from “1” by loading “0” as a counting value when the counting value becomes “3” in the count-up operation. Also, the up/down counter 54 starts to count down from “1” by loading “2” as a counting value when the counting value becomes “3” in the countdown operation.

Further, the up/down counter 54 carries out the count-up operation when the level of the LR_N signal is low, and carries out the countdown operation when the level of the LR_N signal is high. Namely, the up/down counter 54 switches from the count-up operation to the countdown operation in synchronization with a rising point in which the level of the LR_N signal changes from low to high. Conversely, the up/down counter 54 switches from the countdown operation to the count-up operation in synchronization with a falling point in which the level of the LR_N signal changes from high to low.

The comparator 55 compares a predetermined constant (“3” in the present embodiment) with the counting value obtained in the up/down counter 54. If the counting value is the predetermined constant (i.e., 3), a pulse is generated. Thus, a pulse (A2R+B2R)/3 having a frequency that is a third that of the pulse A2R+B2R, i.e., four thirds that of the pulses A and B is generated and output to the T flip-flop 56 (see FIG. 11).

In the T flip-flop 56, a level of the pulse (A2R+B2R)/3 is switched between high and low in synchronization with a rising point of the pulse (A2R+B2R)/3, whereby a pulse (A2R+B2R)/6 having a frequency that is half that of the pulse (A2R+B2R)/3, i.e., two thirds that of the pulses A and B is generated and output to thee microcomputer 16 (see FIG. 11).

As mentioned above, the pulse (A2R+B2R)/6 is a reference pulse signal α that is a reference of the printing position (position of the LED head 22). Both the reference pulse signal α and the pulse (A2R+B2R)/3 are symmetrical as the center of an actual turnback position of the LED head 22. A duty ratio (ratio of a duration when a level of the reference pulse signal a is high in one cycle) of the reference pulse signal α is 50%.

The reference pulse signal α output from the T flip-flop 56 is supplied to the microcomputer 16. Since operations subsequent to this one have already been mentioned above, further explanation of them is omitted here.

Next, patterns of the reference pulse signal α generated for the printing position will be examined.

As mentioned above, a 2-bit up/down counter is used in these examinations as the up/down counter 54. If the counting value becomes “3”and “0” or “2” is loaded, the counting values around the turnback point are any one of “0,” “1” and “2.” Therefore, patterns of all the counting values are examined.

There are three basic examined patterns in which a counting value just before switching is any one of “0,” “1” and “2” in a case of switching from a count-up operation to a countdown operation and there are three types of patterns in which a counting value just before switching is any one of “0,” “1” and “2” in a case of switching from a countdown operation to a count-up operation.

Also, there are two types of patterns in a case of switching from a count-up operation to a countdown operation, and switching from a countdown operation to a count-up operation when an irregular pulse (abnormal pulse) is generated during turnback of the LED head 22 are examined.

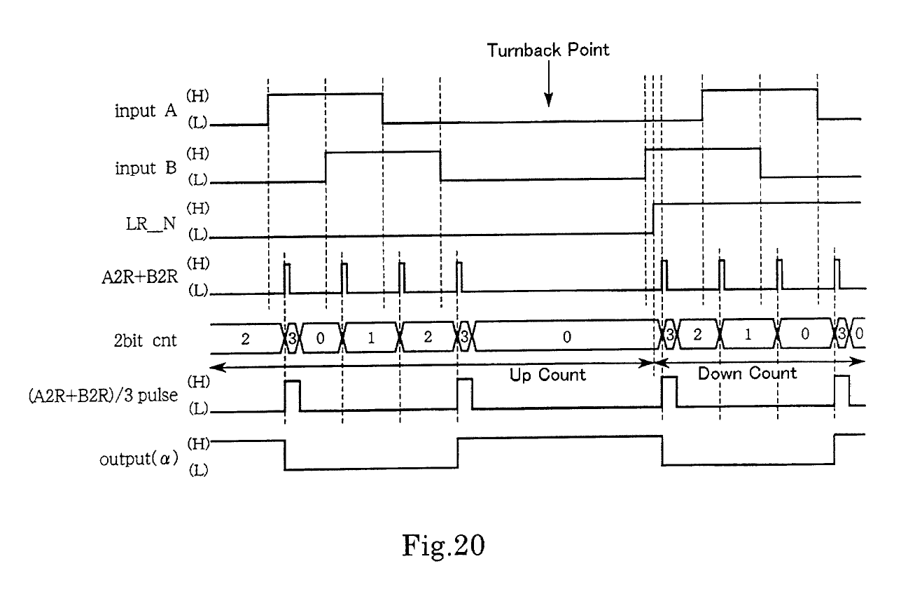

FIGS. 20-27 are timing charts illustrating an operation of an up/down counter 54 etc. when an LED head 22 of the printer 1 shown in FIG. 1 turns back.

FIG. 20 illustrates a case in which the up/down counter 54 switches from a count-up operation to a countdown operation when a counting value of the up/down counter 54 is “0.”

As shown in FIG. 20, since a level of an LR_N signal is low, the up/down counter 54 counts up a pulse A2R+B2R. When the counting value of the up/down counter 54 becomes “3,” a pulse (A2R+B2R)/3 is output to the T flip-flop 56, and “0” is loaded as a counting value.

Then, the level of the LR_N signal switches from low to high. The up/down counter 54 switches from a count-up operation to a countdown operation in synchronization with switching of the level of the LR_N signal, and starts to count down the pulse A2R+B2R from “3” (i.e., it counts “3,” at first).

When the counting value of the up/down counter 54 becomes “3,” a pulse (A2R+B2R)/3 is output to the T flip-flop 56 and “2” is loaded as a counting value. The up/down counter 54 counts down the pulse A2R+B2R from “1.”

A level of an output signal (a) is switched between high and low in synchronization with a rising point of the pulse (A2R+B2R)/3, whereby a reference pulse signal α for the printing position is generated and output to the microcomputer 16.

As can be seen in FIG. 20, the pulse (A2R+B2R)/3 and the reference pulse signal α for the printing position are symmetrical at the center of the actual turnback position of the LED head 22.

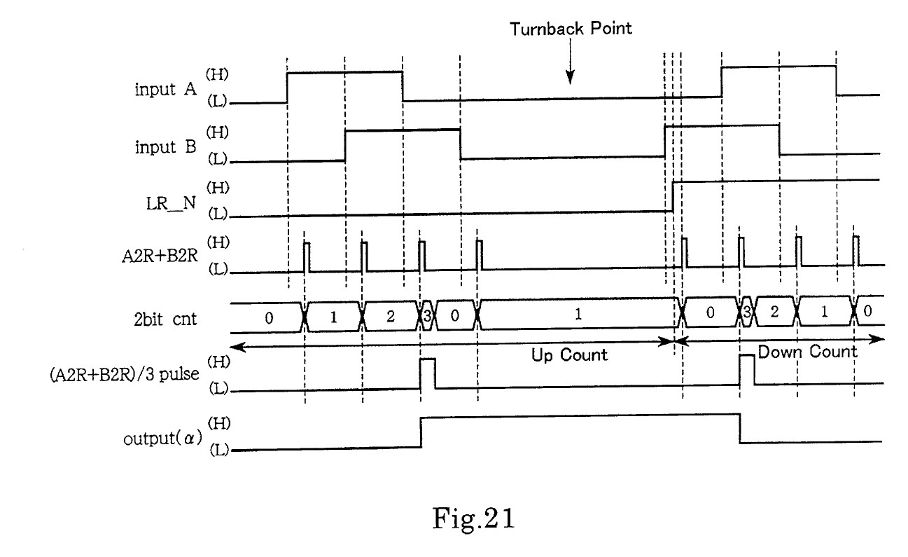

FIG. 21 illustrates a case in which the up/down counter 54 switches from a count-up operation to a countdown operation when a counting value of the up/down counter 54 is “1.”

As shown in FIG. 21, since a level of an LR_N signal is low, the up/down counter 54 counts up a pulse A2R+B2R. When the counting value of the up/down counter 54 becomes “3,” a pulse (A2R+B2R)/3 is output to the T flip-flop 56, and “1” is loaded as a counting value.

Then, the level of the LR_N signal switches from low to high. The up/down counter 54 switches from a count-up operation to a countdown operation in synchronization with switching of the level of the LR_N signal, and starts to count down the pulse A2R+B2R from “0” (i.e., it counts “0,” at first).

When the counting value of the up/down counter 54 becomes “3,” a pulse (A2R+B2R)/3 is output to the T flip-flop 56 and “2” is loaded as a counting value. The up/down counter 54 counts down the pulse A2R+B2R from “1.”

A level of an output signal (α) is switched between high and low in synchronization with a rising point of the pulse (A2R+B2R)/3, whereby a reference pulse signal α for the printing position is generated and output to the microcomputer 16.

As can be seen in FIG. 21, the pulse (A2R+B2R)/3 and the reference pulse signal α for the printing position are symmetrical at the center of the actual turnback position of the LED head 22.

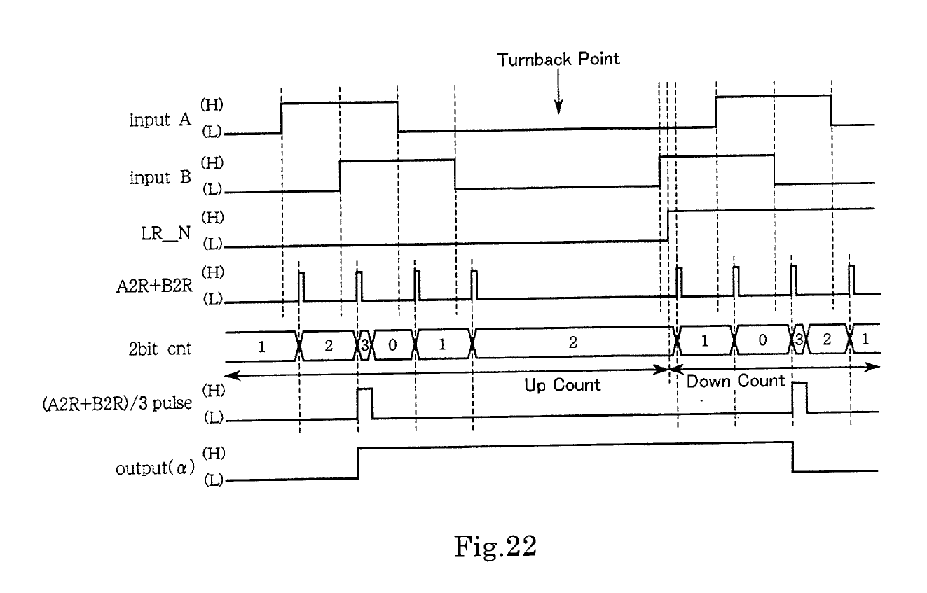

FIG. 22 illustrates a case in which the up/down counter 54 switches from a count-up operation to a countdown operation when a counting value of the up/down counter 54 is “2.”

As shown in FIG. 22, since a level of an LR_N signal is low, the up/down counter 54 counts up a pulse A2R+B2R. When the counting value of the up/down counter 54 becomes “3,” a pulse (A2R+B2R)/3 is output to the T flip-flop 56, and “0” is loaded as a counting value. Then, the counting value becomes “1” when a next pulse A2R+B2R is generated, and subsequently the counting value becomes “2” when a subsequent pulse A2R+B2R is generated.

Then, the level of the LR_N signal switches from low to high. The up/down counter 54 switches from a count-up operation to a countdown operation in synchronization with switching of the level of the LR_N signal, and starts to count down the pulse A2R+B2R from “1” (i.e., it counts “1,” at first).

When the counting value of the up/down counter 54 becomes “3,” a pulse (A2R+B2R)/3 is output to the T flip-flop 56 and “2” is loaded as a counting value. The up/down counter 54 counts down the pulse A2R+B2R from “1.”

A level of an output signal (α) is switched between high and low in synchronization with a rising point of the pulse (A2R+B2R)/3, whereby a reference pulse signal α for the printing position is generated and output to the microcomputer 16.

As can be seen in FIG. 22, the pulse (A2R+B2R)/3 and the reference pulse signal α for the printing position are symmetrical at the center of the actual turnback position of the LED head 22.

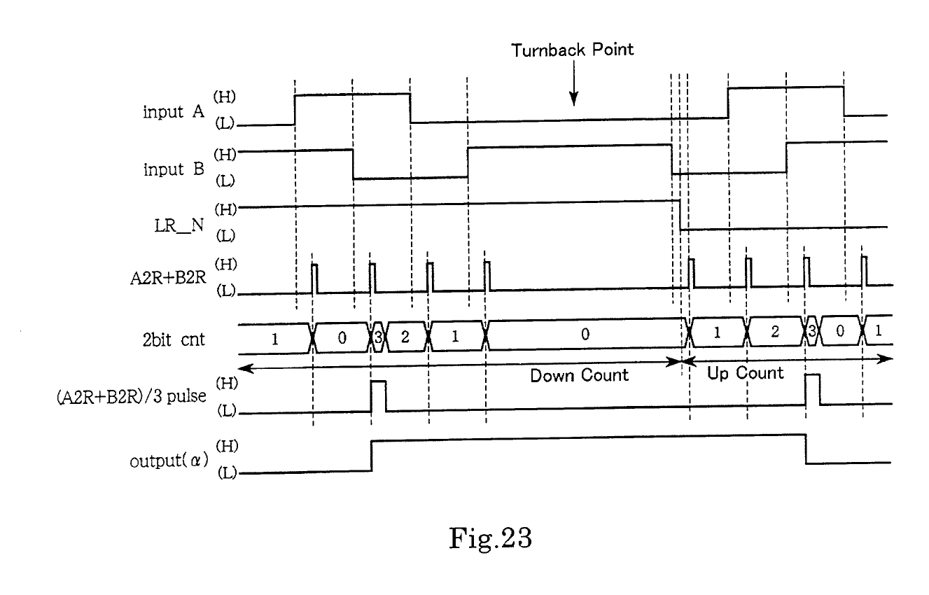

FIG. 23 illustrates a case in which the up/down counter 54 switches from a countdown operation to a count-up operation when a counting value of the up/down counter 54 is “0.”

As shown in FIG. 23, since a level of an LR_N signal is high, the up/down counter 54 counts down a pulse A2R+B2R. When the counting value of the up/down counter 54 becomes “3,” a pulse (A2R+B2R)/3 is output to the T flip-flop 56, and “2” is loaded as a counting value. Then, the counting value becomes “1” when a next pulse A2R+B2R is generated, and subsequently the counting value becomes “0” when a subsequent pulse A2R+B2R is generated.

Then, the level of the LR_N signal switches from high to low. The up/down counter 54 switches from a countdown operation to a count-up operation in synchronization with switching of the level of the LR_N signal, and starts to count down the pulse A2R+B2R from “1” (i.e., it counts “1,” at first).

When the counting value of the up/down counter 54 becomes “3,” a pulse (A2R+B2R)/3 is output to the T flip-flop 56 and “0” is loaded as a counting value. The up/down counter 54 counts up the pulse A2R+B2R from

A level of an output signal (α) is switched between high and low in synchronization with a rising point of the pulse (A2R+B2R)/3, whereby a reference pulse signal α for the printing position is generated and output to the microcomputer 16.

As can be seen in FIG. 23, the pulse (A2R+B2R)/3 and the reference pulse signal α for the printing position are symmetrical at the center of the actual turnback position of the LED head 22.

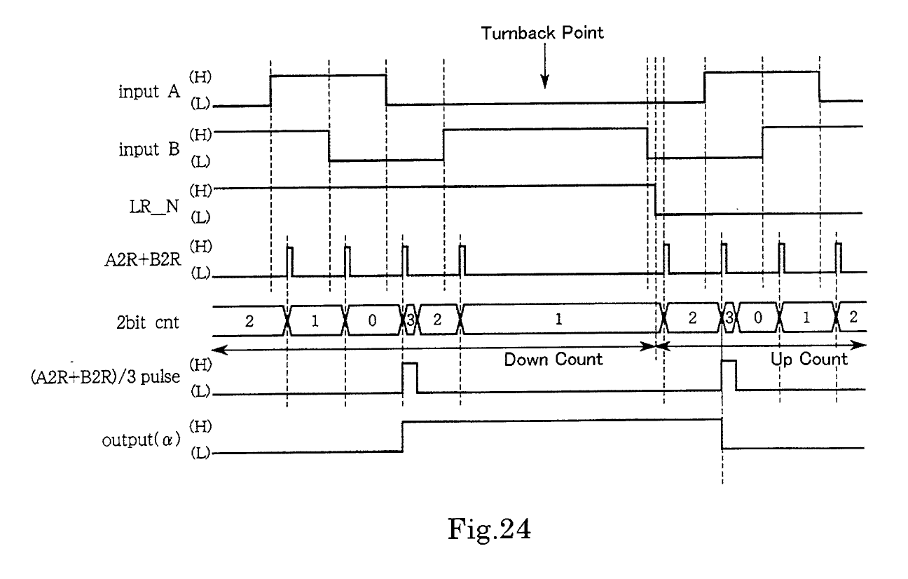

FIG. 24 illustrates a case in which the up/down counter 54 switches from a countdown operation to a count-up operation when a counting value of the up/down counter 54 is “1.”

As shown in FIG. 24, since a level of an LR_N signal is high, the up/down counter 54 counts down a pulse A2R+B2R. When the counting value of the up/down counter 54 becomes “3,” a pulse (A2R+B2R)/3 is output to the T flip-flop 56, and “2” is loaded as a counting value. Then, the counting value becomes “1” when a next pulse A2R+B2R is generated.

Then, the level of the LR_N signal switches from high to low. The up/down counter 54 switches from a countdown operation to a count-up operation in synchronization with switching of the level of the LR_N signal, and starts to count down the pulse A2R+B2R from “2” (i.e., it counts “2,” at first).

When the counting value of the up/down counter 54 becomes “3,” a pulse (A2R+B2R)/3 is output to the T flip-flop 56 and “0” is loaded as a counting value. The up/down counter 54 counts up the pulse A2R+B2R from

A level of an output signal (α) is switched between high and low in synchronization with a rising point of the pulse (A2R+B2R)/3, whereby a reference pulse signal α for the printing position is generated and output to the microcomputer 16.

As can be seen in FIG. 24, the pulse (A2R+B2R)/3 and the reference pulse signal α for the printing position are symmetrical at the center of the actual turnback position of the LED head 22.

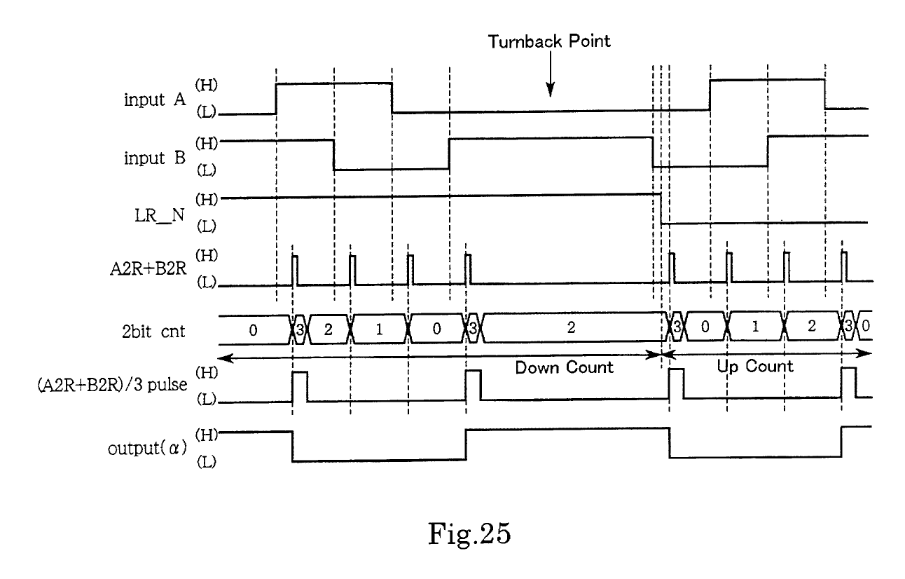

FIG. 25 illustrates a case in which the up/down counter 54 switches from a countdown operation to a count-up operation when a counting value of the up/down counter 54 is “2.”

As shown in FIG. 25, since a level of an LR_N signal is high, the up/down counter 54 counts down a pulse A2R+B2R. When the counting value of the up/down counter 54 becomes “3,” a pulse (A2R+B2R)/3 is output to the T flip-flop 56, and “2” is loaded as a counting value.

Then, the level of the LR_N signal switches from high to low. The up/down counter 54 switches from a countdown operation to a count-up operation in synchronization with switching of the level of the LR_N signal, and starts to count down the pulse A2R+B2R from “3” (i.e., it counts “3,” at first).

When the counting value of the up/down counter 54 becomes “3,” a pulse (A2R+B2R)/3 is output to the T flip-flop 56 and “0” is loaded as a counting value. The up/down counter 54 counts up the pulse A2R+B2R from “1.”

A level of an output signal (α) is switched between high and low in synchronization with a rising point of the pulse (A2R+B2R)/3, whereby a reference pulse signal α for the printing position is generated and output to the microcomputer 16.

As can be seen in FIG. 25, the pulse (A2R+B2R)/3 and the reference pulse signal α for the printing position are symmetrical at the center of the actual turnback position of the LED head 22.

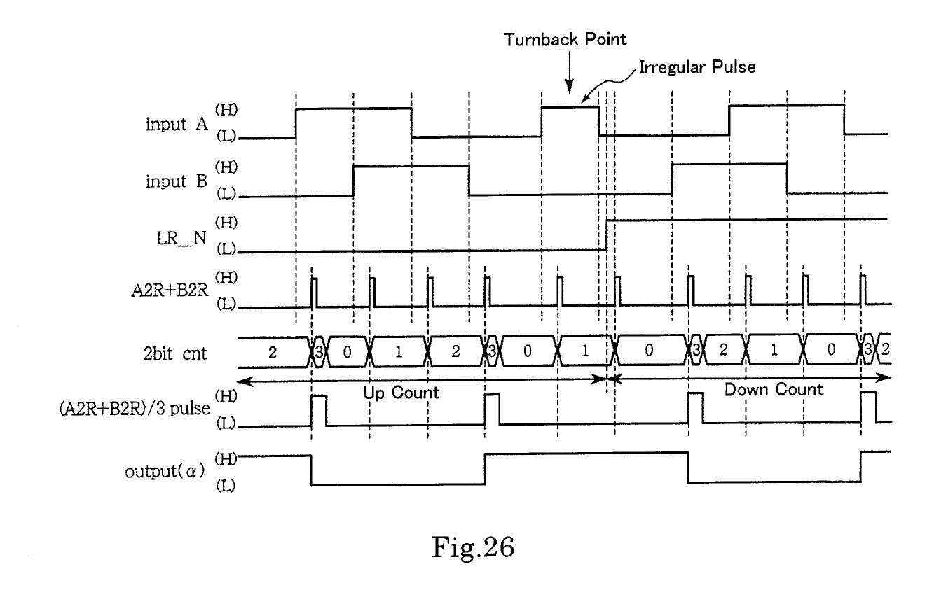

FIG. 26 illustrates a case in which an irregular pulse is generated in an input signal A comprising pulses A during the turnback of the LED head 22, and the up/down counter 54 switches from a count-up operation to a countdown operation when a counting value of the up/down counter 54 is “1.”

As shown in FIG. 26, since a level of an LR_N signal is low, the up/down counter 54 counts up a pulse A2R+B2R. When the counting value of the up/down counter 54 becomes “3,” a pulse (A2R+B2R)/3 is output to the T flip-flop 56, and “0” is loaded as a counting value. Then, the counting value becomes “1” when a next pulse A2R+B2R is generated.

Then, the level of the LR_N signal switches from low to high. The up/down counter 54 switches from a count-up operation to a countdown operation in synchronization with switching of the level of the LR_N signal, and starts to count down the pulse A2R+B2R from “0” (i.e., it counts “0,” at first).

When the counting value of the up/down counter 54 becomes “3,” a pulse (A2R+B2R)/3 is output to the T flip-flop 56 and “2” is loaded as a counting value. The up/down counter 54 counts down the pulse A2R+B2R from “1.”

A level of an output signal (α) is switched between high and low in synchronization with a rising point of the pulse (A2R+B2R)/3, whereby a reference pulse signal α for the printing position is generated and output to the microcomputer 16.

As can be seen in FIG. 26, the pulse (A2R+B2R)/3 and the reference pulse signal α for the printing position are symmetrical at the center of the actual turnback position of the LED head 22.

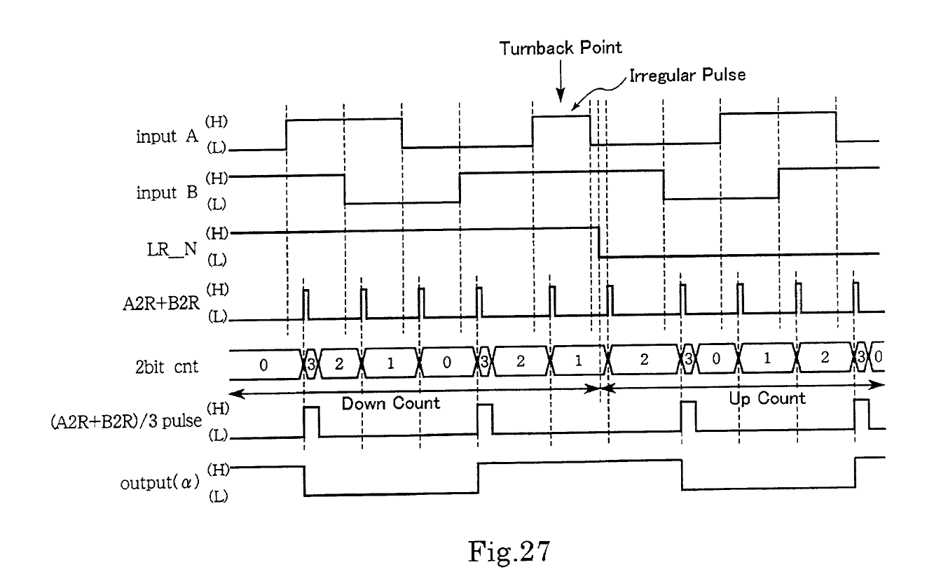

FIG. 27 illustrates a case in which an irregular pulse is generated in an input signal A comprising pulses A during the turnback of the LED head 22, and the up/down counter 54 switches from a countdown operation to a count-up operation when a counting value of the up/down counter 54 is “1.”

As shown in FIG. 27, since a level of an LR_N signal is high, the up/down counter 54 counts down a pulse A2R+B2R. When the counting value of the up/down counter 54 becomes “3,” a pulse (A2R+B2R)/3 is output to the T flip-flop 56, and “2” is loaded as a counting value. Then, the counting value becomes “1” when a next pulse A2R+B2R is generated.

Then, the level of the LR_N signal switches from high to low. The up/down counter 54 switches from a countdown operation to a count-up operation in synchronization with switching of the level of the LR_N signal, and starts to count down the pulse A2R+B2R from “2” (i.e., it counts “2,” at first).

When the counting value of the up/down counter 54 becomes “3,” a pulse (A2R+B2R)/3 is output to the T flip-flop 56 and “0” is loaded as a counting value. The up/down counter 54 counts up the pulse A2R+B2R from

A level of an output signal (α) is switched between high and low in synchronization with a rising point of the pulse (A2R+B2R)/3, whereby a reference pulse signal α for the printing position is generated and output to the microcomputer 16.

As can be seen in FIG. 27, the pulse (A2R+B2R)/3 and the reference pulse signal α for the printing position are symmetrical at the center of the actual turnback position of the LED head 22.

As shown in FIGS. 20-27, the pulse (A2R+B2R)/3 and the reference pulse signal α for the printing position in all examined patterns mentioned above are symmetrical at the center of the actual turnback position of the LED head 22.

The fact that a waveform of the reference pulse signal α is symmetrical at the center of the actual turnback position of the LED head 22 means that in a main scanning direction no gap (shift) of dots (pixels) occurs in an image reproduced on a printing paper, because shapes and phases (positions) of all reference pulse signals α are substantially matched with respect to each line in the main scanning direction, i.e., each way to and from the turnback position of the LED head 22.

As explained above, according to the printer 10 of the present invention, a reference pulse signal α for a printing position having a predetermined resolution is generated by changing resolutions (frequencies) of encoded pulses FG1 (A) and FG2 (B), the printer 10 reproduces (prints out) an image on a printing paper with the position of the LED head 22 determined based on the reference pulse signal α. Thus, a desired printing resolution (resolution of image) can be readily and reliably obtained without changing a type of sensor 28 and linear scale 29 or adding another type of sensor 28 and linear scale 29.

Especially, since the reference pulse signal α for the printing position is generated by changing resolutions (frequencies) of the encoded pulses FG1 (A) and FG2 (B), a reference pulse signal α having a desired resolution can be generated easily. For example, the printer of the present invention can be readily adapted for use in a variety of modes, such as a high resolution mode for high image quality; low resolution mode for a rapid printing time; single resolution printing selected from among a plurality of resolutions; printing with a resolution preset at a factory during manufacture or prior to shipment. Accordingly, the printer of the present invention is versatile.

Further, a production cost of the printer can be reduced because neither the sensor 28 nor the linear scale 29 need be changed or added.

Moreover, a reference pulse signal α for the printing position can be generated, which has a symmetrical waveform with respect to the center of the actual turnback point of the LED head 22 regardless of a number of the pulses A and B generated in one line, and also even in a case that an irregular pulse (abnormal pulse) is generated when the LED head 22 turns back.

Thus, the printer of the present invention can prevent displacement of a printing position (position of the LED head 22), i.e., gap (shift) of dots (pixels) of an image in a main scanning direction, and is thus able to accurately print out (reproduce) an image corresponding to image data on a printing paper.

Further, since the printer 10 carries out a printing operation when the LED head 22 moves both forward and backward (in a reciprocally manner) in a main scanning direction, a printing time can be reduced.

Finally, it is to be noted that the present invention as described above with reference to the foregoing embodiments is not to be taken as being limited in any way to the description of such embodiments, and a wide range of additions and changes may be made to the present invention without departing from its spirit and scope defined in the following claims.

For example, the printer of the present invention may comprise a controlling portion for adjusting (operating) a printing resolution, and may be configured so as to select one from among a plurality of printing resolutions by means of the controlling portion.

The printer mentioned in the present embodiment is a Cycolor type printer, but the present invention is not limited to such a printer. Also, the present invention is not limited to a printer having a system in which a photosensitive printing paper is exposed to reproduce an image on a photosensitive printing paper. Namely, the printer of the present invention may be any printer that carries out a printing operation using a head for printing (printer head) movably (reciprocating motion) mounted on the printer body.

Further, the printer of the present invention may be not only a color (full-color) printer for reproducing (printing) an image with a plurality of colors but also a monochrome printer for reproducing a monochrome image (white and black color image).

What is claimed is:

1. A printer comprising:
a printer body;
a printer head mounted on said printer body in a reciprocally movable manner with respect to said printer body;
a sensor for detecting a movement of said printer head to generate pulse signals;
head turnback position detecting means for detecting a turnback position of said printer head based on the pulse signals output from said sensor; and
pulse resolution changing means for changing a resolution of the pulse signals from said sensor based on a detected result by said head turnback position detecting means and generating a reference pulse signal for a printing position;
wherein the printer is configured so as to carry out a printing operation via said printer head while determining the position of said printer head based on the reference pulse signal for the printing position.

2. The printer according to claim 1, wherein the pulse signals include a first pulse signal and a second pulse signal, the phases of the first and second pulse signals being shifted relative to each other by a predetermined value.

3. The printer according to claim 2, further comprising a scale provided on said printer body;
wherein said sensor is provided on said printer head, and has a light emitting section for emitting light toward said scale and a plurality of light receiving sections for receiving reflected light that is emitted from the light emitting section and reflected from said scale to output signals, and a first pulse signal and a second pulse signal are generated based on the signals from the light receiving sections.

4. The printer according to claim 3, wherein, when said printer head moves in a predetermined direction, the phase of the first pulse signal leads to the phase of the second pulse signal by a predetermined value; and when said printer head moves in a reverse direction, the phase of the first pulse signal lags behind the phase of the second pulse signal by a predetermined value.

5. The printer according to claim 4, wherein the phase shift between the pulses of the first and second pulse signals is 90 degrees, and duty ratios of the pulses of the first and second pulse signals are 50%, respectively.

6. The printer according to claim 2, wherein said head turnback position detecting means determines a turnback position of said printer head at a timing when a level of one of the first and second pulse signals changes twice with a level of the other pulse signal being unchanged.

7. The printer according to claim 2, wherein said head turnback position detecting means compares a level of the pulse of the second pulse signal at a rising point of the pulse of the first pulse signal with a level of the pulse of the second pulse signal at a falling point of the pulse of the first pulse signal, and determines a later timing in the rising and falling points of the first pulse signal as a first timing in a case that both levels of the second pulse signal at the two points are either high or low; and
said head turnback position detecting means also compares a level of the pulse of the first pulse signal at a rising point of the pulse of the second pulse signal with a level of the pulse of the first pulse signal at a falling point of the pulse of the second pulse signal, and determines a later timing in the rising and falling points of the second pulse signal as a second timing in a case that both levels of the first pulse signal at the two points are either high or low; and
wherein said head turnback position detecting means determines the earlier timing in the first and second timings as the turnback position.

8. The printer according to claim 1, wherein said pulse resolution changing means comprises:
an a-multiply pulse signal generating circuit for generating an a-multiply pulse signal having a times frequency of the frequency of the pulse signals from said sensor (here, “a” is any one of two or more integral numbers.); and
a divider for dividing the a-multiply pulse signal so that the reference pulse signal for the printing position becomes substantially symmetrical at the center of an actual turnback point of said printer head on the basis of the detected result of said head turnback position detecting means.

9. The printer according to claim 8, wherein the a is four.

10. The printer according to claim 8, wherein said divider has a counter, and wherein, when said divider divides the a-multiply pulse signal so that a frequency of the divided pulse signal becomes n times that of the a-multiply pulse signal (here, “n” is any one of two or more integral numbers.), said divider carries out a dividing operation by counting up or down a number of pulses of the a-multiply pulse signal by means of the counter and generating pulses in synchronization with n^{th} count, and, when said head turnback position detecting means detects the turnback position of said printer head, the dividing operation is switched between a count-up operation and a countdown operation.

11. The printer according to claim 10, wherein said divider starts to count up the pulses from 1 after a counting value in the counter has been returned to 0 when the counter counts the n^{th} pulse in the count-up operation, and said divider starts to count down the pulses from n−2 after a counting value in the counter has been returned to n−1 when the counter counts the n^{th} pulse in the countdown operation.

12. The printer according to claim 10, wherein said counter is a b-bit up/down counter (here, “b” is any one of two or more integral numbers.), and the n is 2^{b}−1.

13. The printer according to claim 10, wherein said divider generates the reference pulse signal for the printing position by dividing the a-multiply pulse signal so that a frequency of the divided pulse signal becomes n times that of the a-multiply pulse signal and further dividing the divided pulse signal.

14. The printer according to claim 1, wherein a duty ratio of the pulse of the reference pulse signal for the printing position is 50%.

15. The printer according to claim 1, wherein a light source is mounted on said printer head, and the printer is configured so as to reproduce an image on a photosensitive printing paper by exposing the photosensitive printing paper by means of said printer head.

16. The printer according to claim 1, wherein a light source for emitting red light, a light source for emitting green light and a light source for emitting blue light are mounted on said printer head, and the printer is configured so as to reproduce an image on a photosensitive printing paper by exposing the photosensitive printing paper by means of said printer head.

17. The printer according to claim 16, further comprising:
a first group of registers for setting up image data corresponding to the light source for emitting red light, the image data corresponding to the light source for emitting green light, and the image data corresponding to the light source for emitting blue light; and
a second group of registers for holding the image data, which is set up in said first group of registers;
wherein the printer is constructed so as to set up next image data in said first group of registers and to drive each of the light sources mounted on said printer head by using the image data that is held in said second group of registers in parallel.

18. The printer according to claim 16, wherein a plurality of the light sources for emitting red light, a plurality of the light sources for emitting green light and a plurality of the light sources for emitting blue light are mounted on said printer head.

19. The printer according to claim 1, wherein the printer is configured so as to reproduce an image on a printing paper that contains a plurality of photosensitive microcapsules.

20. The printer according to claim 1, wherein the printer is a Cycolor type printer.
